(19) United States
(12) Patent Application Publication
(10) Pub. No.: US 2022/0159969 A1
(43) Pub. Date: May 26, 2022

(54) COMPOSITION AND METHOD FOR ENHANCING SPORE GERMINATION AND BIOLOGICAL EFFICACY

(71) Applicant: DANSTAR FERMENT AG, Zug (CH)

(72) Inventors: Selma ROGALSKA, Hamburg (DE); Tarryn GOBLE, KwaZulu-Natal (ZA)

(73) Assignee: DANSTAR FERMENT AG, Zug (CH)

(21) Appl. No.: 17/614,267

(22) PCT Filed: May 22, 2020
(86) PCT No.: PCT/EP2020/064313

§ 371 Date: Nov. 24, 2021

(30) Foreign Application Priority Data
May 24, 2019 (EP) 19176596.5

(51) Int. Cl. A01N 63/34; A01N 63/32; A01N 63/38

(52) U.S. Cl. CPC A01N 63/34; A01N 63/38; A01N 63/32

(57) ABSTRACT

The present disclosure relates to compositions and methods for improving the ability of a population of biological agents or biological control agents to compete and survive in a field. By improving the population of biological agents, the population of agents is able to grow, compete with other microbial strains and fungi, and provide a greater protection from pathogens.

### TECHNOLOGICAL FIELD

The present disclosure relates to compositions and methods for improving the ability of a population of biological agents or biological control agents to compete and survive in a field.

### BACKGROUND

The use of natural organisms such as bacteria, viruses and fungi to control pests and diseases is of great interest. In particular, fungi are organisms with great potential as biological control agents because they have an extremely high reproductive capacity, a short generation time, and sometimes are very specific in their action, attacking only the host with which they have co-evolved. In addition, fungi have saprophytic phases in which they can survive without the host, and remain in the environment until the host appears again.

Biological solutions have been used, among other things, to promote plant growth, combat plant pathogens, reduce the use of chemicals for soil fertilization and pest management, and to increase nutrient availability and uptake to the plant. It is recognized that the use of these synthetic chemical agents are associated with problems such as non-target effects, environmental pollution, human health problems, as well as the high economic costs involved. However, such chemical agents continue to be in wide use due to their strong activity against important fungal diseases and limited availability of environmentally safer and effective alternatives. With the growing awareness of the harmful effects of many synthetic chemical pesticides on the environment as a whole, there has been a shift in attention to the research and development of more environment-friendly methods of pest and disease control. Unfortunately, biological solutions can sometimes be limited, for example, in their ability to colonize plant tissue or survive under field conditions. Therefore, efforts to apply certain live biological organisms have been limited by the insufficient ability of these biological microorganisms to germinate on minimal carbon source substrates (e.g., a plant tissue following an application of a biological control organism). By remaining in the dormant spore state, such biological microorganisms are unable to perform their beneficial modes of action. A greater germination of such spores or conidia would enable the organisms to regain metabolic activity, and thereby, increase the effectiveness of these biological solutions by colonizing the plant tissue. This greater germination rate can also prevent inactivation or reduction by abiotic factors. Therefore, there is a need in the state of the art to develop an alternative environmentally safe and effective solution to enhance the global efficacy of a biological control agent. This remains a long-standing need in the agricultural industry compared to the hazardous chemicals currently in use.

### SUMMARY OF THE INVENTION

The present disclosure is useful for enhancing the competitiveness of biological agents or biological control agents particularly over other microbial agents. Therefore, the protection from disease-causing agents or pests (e.g. insect or mite pests) is enhanced.

The present disclosure relates to combinations, compositions and methods for improving the ability of a population of biological agents or biological control agents to compete and survive in a field. By improving the population of biological agents or biological control agents, the population of agents is able to grow, compete with other microbial strains and fungi, and provide a greater protection for pathogens or pests, as for example, plant pathogens or insects.

The present disclosure also relates to a composition comprising one or more microorganisms and germinants as well as methods comprising application of the composition to promote faster spore germination of the one or more microorganisms on a substrate or host not optimal for microbial growth and, thus, provide a greater protection against pathogens or pests, as for example, plant pathogens or insects.

Thus, the present invention provides a method for enhancing the germination rate of a microbial spore comprising contacting to a host: (a) one or more microbial spores of a biological agent or biological control agent and (b) one or more germinants, wherein said one or more germinants comprises glycine betaine, a yeast extract, a yeast derivative, or a combination thereof. Upon contact of the one or more microbial spores and the one or more germinants to the host, the one or more microbial spores of the biological agent or biological control agent may exhibit an increased spore germination compared to contacting one or more microbial spores to the host without the one or more germinants. The host may be soil, a pest, a plant or a plant part, optionally wherein the plant part comprises or consists of a seed.

The present invention also provides a method for controlling a plant pathogen or a pest or protecting a plant from a plant pathogen a pest or improving growth, development and/or productivity of a plant, said method comprising contacting soil, a pest, a plant or a plant part with (a) one or more microbial spores of a biological agent or biological control agent and (b) one or more germinants, wherein said one or more germinants comprises glycine betaine, a yeast extract, a yeast derivative, or a combination thereof. The present invention further provides a method for enhancing the efficacy of a biological agent or biological control agent, said method comprising contacting soil, a pest, a plant or a plant part with (a) one or more microbial spores of a biological agent or biological control agent and (b) one or more germinants, wherein said one or more germinants comprises glycine betaine, a yeast extract, a yeast derivative, or a combination thereof. Upon contact of the one or more microbial spores and the one or more germinants to soil, the pest, the plant or the plant part, the one or more microbial spores of the biological control agent may exhibit an improved efficacy in inhibiting plant pathogens or exhibit an increased pest control compared to contacting one or more microbial spores to the host without the one or more germinants or the one or more microbial spores of the biological agent exhibits improved efficacy in improving plant growth, development and/or productivity. The improving the growth, development and/or productivity of a plant may comprise improving at least one of the following: the degree of mycorrhization, the rooting of the plant, the growth of the plant, the height of the plant, the flowering of the plant, the fresh biomass of the plant, the dry biomass of the plant, the yield of the plant, the nutrition of the plant, the resistance of the plant to abiotic stresses, and combinations thereof. The plant part may comprises or consist of a seed. The contacting may comprise foliarly applying to the plant or plant part the one or more microbial spores of a biological control agent and the one or more germinants.

Further provided by the present invention is a method for manufacturing a composition which comprises mixing (a) one or more microbial spores of a biological agent or biological control agent and (b) one or more germinants to obtain a composition comprising (a) the one or more microbial spores of a biological agent or biological control agent and (b) the one or more germinants, wherein said one or more germinants comprises glycine betaine, a yeast extract, a yeast derivative, or a combination thereof. Said method may further comprise mixing the (a) one or more microbial spores of a biological agent or biological control agent and (b) one or more germinants with (c) a carrier to obtain a composition comprising (a) the one or more microbial spores of a biological agent or biological control agent, (b) the one or more germinants and (c) the carrier. Said composition may be for controlling a plant pathogen or a pest or improving growth, development and/or productivity of a plant.

The present invention additionally provides a composition for controlling a plant pathogen or a pest or improving growth, development and/or productivity of a plant, wherein the composition comprises (a) one or more microbial spores of a biological agent or biological control agent; and (b) one or more germinants, wherein said one or more germinants comprises glycine betaine, a yeast extract, a yeast derivative, or a combination thereof. The composition may further comprise (c) a carrier.

The present invention further provides use of an effective amount of (a) one or more microbial spores of a biological agent or a biological control agent and (b) one or more germinants for enhancing the germination rate of the one or more microbial spores of a biological agent or a biological control agent, wherein said one or more germinants comprises glycine betaine, a yeast extract, a yeast derivative, or a combination thereof. The use may enhance the germination rate of the one or more microbial spores of a biological agent or biological control agent thereby controlling a plant pathogen or pest or improving growth, and development and/or productivity of a plant. The use may enhance the germination rate and antimicrobial activity or pesticidal activity of the one or microbial spores of the biological control agent compared to the germination rate and antimicrobial activity or pesticidal activity of the one or more microbial spores of a biological control agent when used without the one or more germinants. The use may enhance the germination rate and the efficacy in improving the plant growth, development and/or productivity of the one or more microbial spores of the biological agent compared to the germination rate and the efficacy in improving plant growth, development and or productivity of the one or more spores of the biological control agent when used without the one or more germinants.

In any of the above-described methods, compositions or uses of the present invention, the one or more germinants may comprise glycine betaine. In any of the above-described methods, compositions or uses of the present invention, the one or more germinants may comprise a yeast extract or a yeast derivative. Preferably, the one more germinants comprises a yeast extract. In any of the above-described methods, compositions or uses of the present invention, the one or more germinants may comprise a combination of glycine betaine and a yeast extract. Preferably, the one or more germinants comprises a combination of glycine betaine and a yeast extract.

In any of the above-described methods, compositions or uses of the present invention, the one or more microbial spores of a biological agent or a biological control agent may be one or more fungal spores. The one or more fungal spores may be one or more spores of a fungus belonging to the genus Chlonostachys, Aureobasidium, Ampelomyces, Beauveria, Metarhizium, Metschnikowia, Myrothecium, Nomuraea, Lecanicillium, Chaetomium, Cordyceps, Coniothyrium, Dactylella, Aspergillis, Paecilomyces, Pasteuria, Nomuraea, Pochonia, Rhizophagus, Serendipita, Trichoderma, Pisolithus, Isaria, Crytococcus or Glomus, and combinations thereof. The one or more fungal spores may be one or more fungal spores of Chlonostachys rosea var. catenulatum, Beauveria bassiana, Cordyceps javanica, Trichoderma asperellum, or combinations thereof. The one or more fungal spores may be one or more entomopathogenic fungal spores. The one or more entomopathogenic fungal spores may be one or more entomopathogenic fungal spores of Beauveria bassiana, Cordyceps javanica, or combinations thereof. The one or more fungal spores may be one or more conidia or chlamydospores. The one or more fungal spores may be one or more fungal spores of Chlonostachys rosea var. catenulatum. Preferably, the Chlonostachys rosea var. catenulatum is C. rosea f. catenulate. More preferably, the C. rosea f. catenulate is C. rosea f. catenulate strain J1446, which was deposited on 19 May 1994 according to the Budapest Treaty under accession number DSM 9212 at the DSM Leibniz Institute DSMZ—German Collection of Microorganisms and Cell Cultures (Inhoffenstr. 7B, D-38124 Braunschweig, Germany).

In specific embodiments of any of the above-described methods, compositions or uses of the present invention: (i) the one or more microbial spores of a biological control agent are one or more spores of C. rosea f. catenulata and the one or more germinants comprises glycine betaine, optionally the C. rosea f. catenulata is strain J1446; (ii) the one or more microbial spores of a biological control agent are one or more spores of C. rosea f. catenulata and the one or more germinants comprises a yeast extract or a yeast derivative, preferably the one or more germinants comprises a yeast extract, and optionally the C. rosea f. catenulata is strain J1446; (iii) the one or more microbial spores of a biological control agent are one or more spores of C. rosea f. catenulata and the one or more germinants comprises a combination of glycine betaine and a yeast extract or a yeast derivative, preferably the one or more germinants comprises a combination of glycine betaine and a yeast extract, and optionally the C. rosea f. catenulata is strain J1446; (iv) the one or more microbial spores of a biological control agent are one or more spores of Beauveria bassiana and the one or more germinants comprises glycine betaine; (v) the one or more microbial spores of a biological control agent are one or more spores of Beauveria bassiana and the one or more germinants comprises a yeast extract or a yeast derivative, preferably the one or more germinants comprises a yeast extract; (vi) the one or more microbial spores of a biological control agent are one or more spores of Beauveria bassiana and the one or more germinants comprises a combination of glycine betaine and a yeast extract or a yeast derivative, preferably the one or more germinants comprises a combination of glycine betaine and a yeast extract; (vii) the one or more microbial spores of a biological control agent are one or more spores of Cordyceps javanica and the one or more germinants comprises glycine betaine; (viii) the one or more microbial spores of a biological control agent are one or more spores of Cordyceps javanica and the one or more germinants comprises a yeast extract or a yeast derivative, preferably the one or more germinants comprises a yeast extract; (ix) the one or more microbial spores of a biological control agent are one or more spores of Cordyceps javanica and the one or more germinants comprises a combination of glycine betaine and a yeast extract or a yeast derivative, preferably the one or more germinants comprises a combination of glycine betaine and a yeast extract; (x) the one or more microbial spores of a biological agent are one or more spores of Trichoderma asperellum and the one or more germinants comprises glycine betaine; (xi) the one or more microbial spores of a biological agent are one or more spores of Trichoderma asperellum and the one or more germinants comprises a yeast extract or a yeast derivative, preferably the one or more germinants comprises a yeast extract; or (xii) the one or more microbial spores of a biological agent are one or more spores of Trichoderma asperellum and the one or more germinants comprises a combination of glycine betaine and a yeast extract or a yeast derivative, preferably the one or more germinants comprises a combination of glycine betaine and a yeast extract.

In any of the above-described methods, compositions or uses of the present invention, the plant pathogen may be a fungus or an oomycote. In any of the above-described methods, compositions or uses of the present invention, the plant pathogen belongs to the genus Botrytis, Erysiphe, Rhizoctonia, Venturia, Didymella, Pythium, Phytophthora, Fusarium, Pseudoidium, Podoshaera and combinations thereof. The plant pathogen may belong to the genus Botrytis, preferably wherein the plant pathogen is Botrytis cinerea. The plant pathogen may belong to the genus Erysiphe, preferably wherein the plant pathogen is Erysiphe necator. The plant pathogen may belong to the genus Rhizoctonia, preferably wherein the plant pathogen is Rhizoctonia solani, Rhizoctonia bataticola; Rhizoctonia fragariae; Rhizoctonia leguminicola or Rhizoctonia oryzae, preferably wherein the plant pathogen is Rhizoctonia solani. The plant pathogen may belong to the genus Venturia, preferably wherein the plant pathogen is Venturia inaequalis. The plant pathogen may belong to the genus Pseudoidium, preferably wherein the plant pathogen is Pseudoidium neolycopersici. The plant pathogen belongs to the genus Podoshaera, preferably wherein the plant pathogen is Podosphaera xanthii.

In any of the above-described methods, compositions or uses of the present invention, the plant pathogen may be an insect pest or a mite pest. The insect pest may belong to the species Diuraphis noxia, Bemisia argentifolii, Bemisia tabaci, Trialeurodes vaporariorum, Aleyrodes lonicerae, Diaphorina citri, Euphyllura olivine, Aphis gossypii, Myzus persicae, Macrosiphum euphorbiae, Aulacorthum solani, Heliothrips haemorrhoidalis, Frankliniella occidentalis, Frankliniella schulzei, Thrips tabaci, Scirtothrips dorsalis, Hercinothrips femoralis, Dalbulus maidis, Phenacoccus solenopsis, Pseudococcus longispinus, Paracoccus marginatus, Mahanarva fimbriolata, Deois flavopicta, Zulia entreriana, Notozulia entreriana, Hypothenemus hampei, Hedypathes betulinus, Cosmopolites sordidus, Gonipterus scutellatus, Agriotes spp., Plutella xyllostella, Helicoverpa armigera, Otiorhyncus sultacus, Fungus gnats, Exomala orientalis, Sciaridae, Otiorhynchus sulcatus, Strophosoma melanogrammum, S. capitatum, Phyllopertha horticola, Amphimallon solstitialis, Daktulosphaira vitifoliae, Diabrotica virgifera, Spodoptera spp, Oligonychus ilicis, Planococcus citri, Anthonomus grandis, Brevicoryne brassicae or Sphenophorus levis. The mite pest may belong to the species Tetranychus urticae, Tetranychus cinnabarinus, Brevipalpus phoenicis, Panonychus ulmi, Byrobia rubrioculus, Aculus schlectendali, Aculops lycopersici, Ixodes scapularis or Ixodes pacificus.

In any of the above-described methods, compositions or uses of the present invention, the pest may belong to the species Bemisia tabaci, Bemisia argentifolii, Trialeurodes vaporariorum, Hypothenemus hampei, Cosmopolites sordidus, Sphenophorus levis, Tetranychus urticae, Anthonomus grandis, Diaphorina citri, Helicoverpa armigera, Frankliniella occidentalis, Frankliniella schulzei, Thrips tabaci, Aphis gossypii, Myzus persicae, Oligonychus ilicis, Planococcus citri, Mahanarva fimbriolata, Agriotes spp, Diabrotica spp or Dalbulus maidis. Preferably, the pest is Bemisia tabaci, more preferably the pest is Bemisia tabaci (Gennadius) (Hemiptera: Aleyrodidae).

In any of the above-described methods, compositions or uses of the present invention, said (a) one or more microbial spores of a biological agent or biological control agent, and (b) one or more germinants may be used simultaneously, separately or sequentially. Preferably, said (a) one or more microbial spores of a biological agent or biological control agent; and (b) one or more germinants are used simultaneously.

In specific embodiments of any of the above-described methods or uses of the present invention: (i) the one or more germinants comprises or consists of glycine betaine, and glycine betaine is applied to soil or to the host, plant or plant part at a concentration of at least 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or 5%; (ii) the one or more germinants comprises or consists of a yeast extract or a yeast derivative, and the yeast extract or the yeast derivative is applied soil or to the host, plant or plant part at a concentration of at least 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or 5%; and/or (iii) the one or more microbial spores of a biological agent or a biological control agent is applied to soil or to the host, plant or plant part or the one or more microbial spores of a biological agent or a biological control agent at a concentration of at least about 1×10⁶, about 1×10⁷, about 1×10⁸, about 1×10⁹, about 1×10¹⁰, about 1×10¹¹ or about 1×10¹² CFU/g.

In specific embodiments of any of the above-described compositions of the present invention: (i) the one or more germinants comprises or consists of glycine betaine, and the glycine betaine is present in the composition at a concentration of at least 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or 5%; (ii) the one or more germinants comprises or consists of a yeast extract or a yeast derivative, and the yeast extract or the yeast derivative is present in the composition at a concentration of at least about 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or 5%; and/or (iii) the one or more microbial spores of a biological agent or a biological control agent is present in the composition at a concentration of at least about 1×10⁶, about 1×10⁷, about 1×10⁸, about 1×10⁹, about 1×10¹⁰, about 1×10¹¹ or about 1×10¹² CFU/g.

In any of the above-described methods, compositions or uses of the present invention, the plant or plant part may be cereals, maize, rice, grasses, sugarcane, leguminous plants, forage crop, oil- and protein-rich plants, vegetable crops, fruit trees, viticulture crops, urban crops, or ornamental crops.

In any of the above-described methods, compositions or uses of the present invention, the one or more germinants may comprise or consist of a yeast extract, and the yeast extract may be a soluble yeast extract.

In any of the above-described methods, compositions or uses of the present invention, the one or more germinants may comprise or consist of a yeast derivative. The yeast derivative may be selected from inactive yeast, yeast cell walls, and combinations thereof. The yeast cell walls may be a yeast cell wall fraction, a yeast cell wall product, or a combination thereof.

### FIGURES

Having thus generally described the nature of the invention, reference will now be made to the accompanying drawings, showing by way of illustration, a preferred embodiment thereof, and in which:

FIG. 1 shows the percent germination rate of Prestop® 0.025% (C. rosea f. catenulata J1446 spores) in combination with glycine betaine (0.06% and 0.6%) or yeast extract (0.04% and 0.2%) on leaf discs over 24 hour period in comparison with the sole application of Prestop® 0.025%.

FIG. 2 shows measurements of C. rosea f. catenulata J1446 final growth diameters from leaf discs cut after (a) 1 day, (b) 2 days (c) 3 days or (d) 6 days after inoculation in the greenhouse and a further 6 days of incubation on plates. Prestop® was applied at a concentration of 0.025%, glycine betaine at a concentration of 0.06% and 0.6% or yeast extract at a concentration of 0.04% and 0.2%.

FIG. 3 shows the efficacy of the combination of Prestop® (C. rosea f. catenulata J1446) at a concentration of 0.003% and glycine betaine at a concentration of 0.05% and 0.2% in controlling Botrytis cinerea compared with treatments with only Prestop® and only glycine betaine.

FIG. 4 shows the efficacy of a lower dose rate of Prestop® (C. rosea f. catenulata J1446) at a concentration of 0.001% in combination with glycine betaine (at a concentration of 0.06% or 0.08%) in controlling Botrytis cinerea compared to the sole application of Pretop® and glycine betaine.

FIG. 5 shows the efficacy of Prestop® (C. rosea f. catenulata J1446) at a concentration of 0.7 g/L in combination with glycine betaine at a concentration of 0.5 g/L on the development of powdery mildew on vine cuttings compared to the application of water or the sole application of Prestop® and glycine betaine.

### DETAILED DESCRIPTION

The present disclosure allows the increase of spore germination of biological agents or biological control agents and, thus, improving the ability of biological agents or biological control agents to compete and survive in a field setting. By stimulating or improving the population of biological agents or biological control agents, the population is able to grow, compete with other microbial organisms and provide a better protection for pathogens as, for example, plant pathogens or pests.

As the germination of spores constitutes the first step in the fungal colonization process, a faster and greater activation of germination will lead to a greater colonization (and also a greater sporulation and production of conidia) and establishment of beneficial fungi.

As known in the art, fungi may be used as biological agents or biological control agents. Indeed, spores are the main mechanism of inoculation of these fungi and therefore increasing the spore germination of fungal biological control agents allows, amongst other, for a greater or faster growth and colonization of the plant tissue. Indeed, soil, pest, plant parts or plant are not always an optimal substrate or host for microbial growth. Furthermore, the results of the present studies have allowed to link increased (or a greater) germination rate of microbial spore of a biological agent or biological control agent with improved, increased or enhanced biological activity or biological control activity.

The present disclosure is directed to a method for controlling a plant pathogen or a pest or protecting a plant or plant part against a plant pathogens or a pest comprising contacting a plant or plant part with (a) one or more microbial spores of a biological agent or biological control agent; and (b) one or more germinants. Interestingly, the use of the one or more germinant of the present disclosure makes it possible to reduce the concentration of the biological agent or biological control agent (i.e. reduce the concentration of the one or more microbial spores) while demonstrating an effect comparable or superior to that observed when normal doses of biological agent or biological control agent are used.

The present disclosure also relates to a method for enhancing the germination of a microbial spore of a biological agent or biological control agent comprising contacting one or more microbial spores of a biological agent or biological control agent and one or more germinants to a host, wherein upon contact of the one or more microbial spores and the one or more germinants to a host, the one or more microbial spores of the biological agent or the biological control agent exhibit increased spore germination on the host in the presence of the one or more germinants compared to contacting one or more microbial spores of the biological agent or biological control agent on a plant or plant part without the one or more germinants. As used herein, the term “host” means a plant material, soil, pests, insects or nematodes. In an embodiment, the host is a an insect, a mite, a plant or a plant part.

In a yet another aspect, a method for inducing the germination of a microbial spore is described herein. In one embodiment, the method comprises inducing the germination of a microorganism comprising foliarly applying or contacting one or more microbial spores and one or more germinants to a plant or plant part, wherein upon foliar application of the one or more microbial spores and the one or more germinants to a plant or plant part, the one or more microbial spores exhibit increased germination on the plant or plant part in the presence of the one or more germinants compared to the foliar application of one or more microbial spores alone (i.e., without one or more germinants) on a plant or plant part.

In another embodiment, the present disclosure provides a combination of components or a composition comprising (a) one or more microbial spores of a biological agent or biological control agent; and (b) one or more germinants, wherein said composition controls a plant pathogen or a pest. The (a) one or more microbial spores of a biological agent or biological control agent; and (b) one or more germinants are present in a form that can be delivered simultaneously, sequentially or separately from each other to a plant or plant part or a pest. By the term “combination” as used herein, this term means two or more substances in proximity to one another and/or used together, regardless of whether a carrier is included. The composition comprising (a) one or more microbial spores of a biological agent or biological control agent; and (b) one or more germinants may be considered a combination. As used herein, the term “delivering simultaneously” means that (a) one or more microbial spores of a biological agent or biological control agent; and (b) one or more germinants are delivered to a plant or plant part or a pest at the same time or substantially at the same time via the same mode of application. As used herein, the term “delivering separately” means that (a) one or more microbial spores of a biological agent or biological control agent; and (b) one or more germinants are delivered to a plant or plant part or a pest at the same time or substantially at the same time via a different mode of application. As used herein, the term “delivering sequentially” means that (a) one or more microbial spores of a biological agent or biological control agent; and (b) one or more germinants are delivered to a plant or plant part or a pest at different times (i.e. (a) can be before or after (b)), the mode of application being identical or different.

Alternatively, the combination of microbial spores of a biological agent or biological control agent and germinants of the present disclosure can be used to significantly reduce diseases or pests. More particularly, the present disclosure provides a use of an effective amount of (a) one or more microbial spores; and (b) one or more germinants for enhancing the germination of a microbial spore and thereby controlling a plant pathogen or a pest.

As used herein, the term “biological agents”, “biological control agent(s)” are all used interchangeably and means any biological organisms which has a biological activity in a seed, a plant, or a plant part or against a pest and/or capable of having one or more beneficial properties to a plant or a plant part (e.g. capable of promoting plant growth, capable of having fungicidal activity, capable of having pesticidal activity, etc). “Biological agents” or “biological control agents” of the present disclosure include microorganisms (e.g. fungi) that control disease-causing plant pathogens or pests (i.e. insects, mites or nematodes) and/or promote plant health, growth, and yield. Non-limiting examples of “biological activity” include N2 fixation, phosphate solubilization, plant growth-enhancement, pesticidal activity, bio-pesticidal (e.g. bioinsecticidal or bionematicidal) activity, bio-fungicidal activity, etc.

As used herein, the terms “control” or “controlling” refer to reduction in numbers of plant pathogens or pests, particularly insect or mite pests, accomplished using the composition of the present disclosure. Concerning control of plant pathogens, the composition or method of the present disclosure is useful for imparting to plants protection against plant pathogens, to modulate, reduce, prevent or ameliorate an infection caused by a plant pathogen. Concerning the reduction of pests (e.g. insects, mites or nematodes), it is generally comprehended that it is the reduction in numbers or eradication of pests or inhibition of their rate of reproduction.

As used herein, the term “improved, increased or enhanced biological control activity (or efficiency) or fungicial activity (or efficiency) means that there is an improved or enhanced efficacy in the inhibition of plant pathogenic fungi (or fungal spores) or pests. Such improved inhibition includes, but is not limited to, a decreased growth of said pathogenic fungi, mycelium and/or production of their spores or a reduction of pests as mentioned above. As used herein “improved, increased or enhanced biological control activity or efficacy” means that there is an improved, increased, enhanced or superior overall efficacy in biocontrol or biological control, such as in context with a biological control application in plants or against pests compared to the biological control efficacy of the biological control agent without the presence of the one or more germinants.

In the context of the present disclosure, the term “improved, increased or enhanced biological activity (or enhance a biofertilization activity)” means increased plant yield or increased the growth of plants, the height of plants (e.g., increased biomass (the fresh biomass and/or the dry biomass), the flowering, increased fruit number, increased bolls, increased seed number or size, or a combination thereof as measured by any methods known in the art), increased root number, increased root mass, increased root volume, increased leaf area, increased plant stand, increased plant vigor, faster seedling emergence (i.e., enhanced emergence), faster germination, (i.e., enhanced germination), increased the degree of mycorrization, the nutrition, the resistance to abiotic stress, or combinations thereof. Mycorrhizal fungi and, for example, the fungus Trichoderma (e.g. T. asperellum (an example is the product Quality®, Lallemand) have this ability to promote or stimulate plant growth, plant development or plant health.

In an embodiment, the biological control agent is a fungal biological control agent. Any fungal biological or biological control agent producing spores can be used in the context of the present disclosure. Particular fungal microorganisms of interest include, for example, but are not limited to, strains of the Chlonostachys, Aureobasidium, Ampelomyces, Beauveria, Metarhizium, Metschnikowia, Myrothecium, Nomuraea, Lecanicillium, Chaetomium, Cordyceps, Coniothyrium, Dactylella, Aspergillus, Paecilomyces, Pasteuria, Pochonia, Rhizophagus, Serendipita, Trichoderma, Pisolithus, Isaria, Crytococcus or Glomus. Other fungi example that can be used in the context of the present disclosure are Endomycorrhiza including but not limited to, arbuscular mycorrhizal fungi (Glomeraceae, Claroideglomeraceae, Gigasporaceae, Acaulosporaceae, Diversisporaceae, Sacculosporaceae, Pacisporaceae, Ambisporaceae, Archaeosporaceae, Paraglomeraceae) and Sebacindïd mycorrhiza (intra-radical endophytic Sebacinaceae). Ectomycorrhiza (including intra-radical Hartig net-forming Basidiomycetes, Ascomycetes and Zygomycetes) and Ericoïd mycorrhiza (intra-radical endophytic Basidiomycetes, Ascomycetes and Zygomycetes of Ericaceae plants) could also be used.

In the context of the present disclosure, the biological control agent may be the fungus C. rosea. Any species or strains of C. rosea may be used. Indeed, many isolates of C. rosea are highly efficient antagonists against several plant pathogenic fungi. The biological control agent C. rosea is an antagonistic fungal plant pathogen that is widely present in soil and can produce a series of antibacterial metabolites. In an embodiment, C. rosea is C. rosea f. catenulata. In a further embodiment, the fungus is C. rosea f. catenulata J1446. This strain has been deposited on 19 May 1994 according to the Budapest Treaty to the DSM depositary (DSM Leibniz Institute DSMZ—German Collection of Microorganisms and Cell Cultures (Inhoffenstr. 7B, D-38124 Braunschweig, Germany) under the accession number DSM 9212. C. rosea f. catenulata J1446 is commercially available under the trademark PRESTOP® or LALSTOP G46 (Lallemand (Verdera, Finland)). In an embodiment, the one or more microbial spores is an entomopathogenic fungal spores. In another particular embodiment, the one or more entomopathogenic fungal spores (e.g. conidia) are one or more entomopathogenic fungal spores of Beauveria (e.g. B. bassiana (an example is the product Granada® from Lallemand) or Cordyceps (e.g. C. javanica) can also be used in the context of the present disclosure.

As used herein, the terms “spore” or “microbial spore” has its normal meaning which is well known and understood by those of skill in the art. As used herein, the terms “spore” and “microbial spore” mean a microorganism in its dormant, protected state. In the context of the present disclosure, the term “one or more microbial spores” refers to “one or more microbial spores” of a biological control agent. In a preferred embodiment, the term “one or more microbial spores” refers to one or more fungal spores. In a particular embodiment, fungal spores include sexually (e. g. oospores, zygospores or ascospores) and asexually (e.g. conidia, chlamydospores, blastospores, uredospores, teleutospores and ustospores) formed spores. The “fungal spores” also include mycelium or mycelium fragments. In a particular embodiment, the fungal spores are conidia. In a particular embodiment, the fungal spores are chlamydospores.

As used herein, the term “germinant(s)” or “inducer(s)” means any substance or compound that induces increases or enhances the germination rate of microbial spores of biological agents or biological control agent e.g., a substance or compound that induces the germination of a microbial spore of biological agents or biological control agent, such as a fungal spore and allows a greater colonization and efficacy of the biological agents or biological control agents. In an embodiment, the “germinant(s)” or “inducer(s)” of the present disclosure can also increase sporulation. The “germinant(s)” or “inducer(s)” of the present disclosure can be seen as having a prebiotic activity. Prebiotics are defined as substances that selectively stimulate microorganisms providing a beneficial effect on the health of the host and competitive advantage. This definition can be extended both for use in human health, the food industry and for application in agriculture since these are a group of compounds based on vitamins, minerals, amino acids and proteins that can act by stimulating the growth and activity of microorganisms.

In the context of the present disclosure, examples of germinants of fungal biological control agent are glycine betaine, yeast extracts, or a combination thereof.

In an embodiment, the germinant used in the context of the present disclosure is glycine-betaine. Glycine-betaine extracted from sugar beet is commercially available for example under the trademark of IntraCell®, Greenstim®, Bluestim®, Osmopro® or LALSTIM Osmo® (Lallemand). Other betaine products, such as betaine monohydrate, betaine hydrochloride and raw betaine liquids, are also commercially available and they can be used for the purposes of the present disclosure.

All types of commercially available yeast extract or yeast derivatives may be used in the context of the present invention. The term “yeast fraction” encompasses substances obtained by separation of the cell walls (e.g. the shells) from the rest of the yeast cell. The term “yeast cell wall” corresponds to the shells of the yeast cells with the exclusion of the content of the yeast cells. The “yeast extract” corresponds to the content of the yeast cells with the exclusion of the cell walls (e.g. the shells). More particularly, the term “yeast extract” refers to the content of the yeast cells, said content being obtained by any suitable extraction method known to those skilled in the art. Thus, more particularly, the term “yeast extract” encompasses the water soluble components of the yeast cell. Generally, yeast extracts are produced by (a) subjecting a yeast to autolystate; (b) subjecting the autolysate to solid/liquid separation; and (c) recovering the liquid fraction, i.e. a soluble yeast extract. Preferably, the yeast extract used in the context of the present invention is a soluble yeast extract. The term “inactive yeast” encompasses yeasts that have been killed by any physical, chemical or physicochemical process. Most commonly, yeasts are killed by heat shock at the end of the production process and then dried. The term “yeast derivatives” covers inactive yeast, yeast cell wall fraction or yeast cell wall products. The yeast extract or the yeast derivative (e.g. the yeast cell walls or the inactive yeast) used in the present invention can be from any yeast species, preferably a yeast species of the genus Saccharomyces, Kluyveromyces, Candida or Torula. In preferred embodiments of any of the methods, compositions or uses of the present invention, the yeast extract is a soluble yeast extract and is from S. cerevisiae.

As used herein, the terms “increased germination”, “increased germination rate”, “enhanced germination” and variations thereof, is intended to mean: an increase in the proportion of applied spores that germinate in the presence of a germinant when compared to the proportion of applied spores that germinate in the absence of a germinant; and/or an increase in speed by which applied spores germinate in the presence of a germinant when compared to the speed by which applied spores germinate in the absence of a germinant.

As used herein, the terms “plant(s)” and “plant part(s)” means all plants and plant populations such as desired and undesired wild plants or crop plants (including naturally occurring crop plants). Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material and vegetative and generative propagation material (e.g., cuttings, tubers, rhizomes, off-shoots and seeds, etc.). The combination of the present disclosure may be applied to any types of plants (i.e. to both leguminous or non-leguminous plants). Examples of plants include, but are not limited to, cereals (such as wheat, barley, oat, rye, triticale), maize, rice, grasses, sugarcane, cotton, leguminous plants (such as alfalfa, clover, sainfoin, etc.), forage crop (such as ryegrass, fescues, cocksfoot, festulolium, vetch, forage turnips, forage radishes, etc.), oil- and protein-rich plants (such as soybeans, colza, peas, fava beans, white lupin, sunflower, etc.), vegetable crops (such as tomatoes, lettuce, cucumbers, bell peppers, eggplants, zucinnis, etc.), fruit trees or fruit bushes (such as, strawberries, blueberries, raspberries, etc.), viticulture (wine and table grapes) or urban and ornamental trees and crops (such as flower production, turfgrass, nurseries, etc.).

As used herein, the terms “controlling a plant pathogen”, “controlling a pest”, “controlling an insect pest”, “protecting a plant from a pathogen (as a plant pathogen, a pest or an insect pest)” refers to one or more of inhibiting or reducing the growth, germination, reproduction, and/or proliferation of a pathogen (e.g. a plant pathogen or an insect pest) of interest; and/or killing, removing, destroying, or otherwise diminishing the occurrence and/or activity of a pathogen of interest. As outlined in further detail herein, in specific embodiments, the biological control agent controls one or more pathogenic fungi such as, for example, Botrytis spp. (e.g. B. cinerea), Didymella spp., Pythium spp., Phytophthora spp., Fusarium spp., Rhizoctonia spp. (e.g. Rhizoctonia solani, Rhizoctonia bataticola; Rhizoctonia fragariae, Rhizoctonia leguminicola or Rhizoctonia oryzae), Verticillium spp., Cladosporium spp., Verticillium spp., Podosphaera spp., Cladosporium spp., Sclerotinia spp. (e.g. S. sclerotiorum), Alternaria spp., Monilia spp., Monilinia spp., Colletotrichum spp., Cladosporium spp., Oidium spp. Didymella spp., Microdochium spp., Mycosphaerella spp., Puccinia spp., Septoria spp., Phaeosphaeria spp., Tapesia spp., Gaeumannomyces spp., Cochliobolus spp. Stagonospora spp., or Pseudoidium spp. The following pathogens can be also encompassed by the present disclosure: Oidium anacardii, Oidium lycopersici, Erysiphe betae, Oidium ericinum, Leveillula taurica, Golovinomyces cichoracearum, Podosphaera fusca, Leveillula taurica, Podosphaera myrtillina, Podosphaera spiraeae, Oidium neolycopersici, Sphaerotheca verbenae, Erysiphe necator (Uncinula necator), Erysiphe vibumi, Erysiphe hedwigii, Podosphaera tridactyla, Microsphaera penicillata, Podosphaera clandestina, Podosphaera euphorbiae, Oidium heveae, Microsphaera polonica, Oidium dianthii, Neoerysiphe galeopsidis, Oidium tingitaninum, Microsphaera berberidis, Golovinomyces cynoglossi, Blumeria graminis, Erysiphe lonicerae, Erysiphe cruciferarum, Golovinomyces orontii, Leveillula cucurbitacearum, Podosphaera fusca (syn. Sphaerotheca fuliginea), Microsphaera begoniae, Plasmapora viticole, Phytophtora infentans Venturia inaequalis, Pseudoidium neolycopersici or Podosphaera xanthii.

In another embodiment, the composition, combination or method of the present disclosure can control pests such as insect pests or mites pests. Examples of insect pests or mites pests are acari, hemipterous, homoterous pests, thysanopterous pests, isopterous pests, lepidopterous pests, coleopterous pests, orthopterous pests, hymenopetrous pests or dipterous pests, etc.

The entomopathogen fungal spores of the present disclosure can control, for examples, insect pest belonging to the species Diuraphis noxia, Bemisia argentifolii, Bemisia tabaci, Trialeurodes vaporariorum, Aleyrodes lonicerae, Diaphorina citri, Euphyllura olivine, Aphis gossypii, Myzus persicae, Macrosiphum euphorbiae, Aulacorthum solani, Heliothrips haemorrhoidalis, Frankliniella occidentalis, Frankliniella schulzei, Thrips tabaci, Scirtothrips dorsalis, Hercinothrips femoralis, Dalbulus maidis, Phenacoccus solenopsis, Pseudococcus longispinus, Paracoccus marginatus, Mahanarva fimbriolata, Deois flavopicta, Zulia entreriana, Notozulia entreriana, Hypothenemus hampei, Hedypathes betulinus, Cosmopolites sordidus, Gonipterus scutellatus, Agriotes spp., Plutella xyllostella, Helicoverpa armigera, Otiorhyncus sultacus, Fungus gnats, Exomala orientalis, Sciaridae, Otiorhynchus sulcatus, Strophosoma melanogrammum, S. capitatum, Phyllopertha horticola, Amphimallon solstitialis, Daktulosphaira vitifoliae, Diabrotica virgifera, Spodoptera spp, Oligonychus ilicis, Planococcus citri, Anthonomus grandis, Brevicoryne brassicae or Sphenophorus levis. In an embodiment, the pests belongs to the species Bemisia tabaci (Gennadius) (Hemiptera: Aleyrodidae), Bemisia argentifolii, Trialeurodes vaporariorum, Hypothenemus hampei, Cosmopolites sordidus, Sphenophorus levis, Tetranychus urticae, Anthonomus grandis, Diaphorina citri, Helicoverpa armigera, Frankliniella occidentalis, Frankliniella schulzei, Thrips tabaci, Aphis gossypii, Myzus persicae, Oligonychus ilicis, Planococcus citri, Mahanarva fimbriolata, Agriotes spp, Diabrotica spp or Dalbulus maidis.

In another embodiment, the entomopathogen fungal spores of the present disclosure can control, for examples, mite pest belonging to the species Tetranychus urticae, Tetranychus cinnabarinus, Brevipalpus phoenicis, Panonychus ulmi, Byrobia rubrioculus, Aculus schlectendali, Aculops lycopersici, Ixodes scapularis or Ixodes pacificus.

The combination or composition according to the present disclosure can be applied by contacting plant, plant part, soil or a pest by any means known to the artisan skilled in the art. The term “contacting” as used herein means causing a plant, plant part, soil or a pest to come into proximity with an exogenous liquid or solid (such as a powder) form of a combination or composition according to the disclosure. Examples of such methods include, but are not limited to dipping, immersing, spraying, misting, fogging, coating, dusting or soaking application methods. The application forms and methods depend entirely on the intended purposes in order to ensure the finest and uniform distribution of the one or more microbial spores of a biological agent or biological control agent and one or more germinants onto the plant or plant part, soil or pests. In an embodiment, the application or contacting step is repeated more than one (i.e. that the contacting step may be repeated twice, three times, four times, five times, six times, etc).

In a more particular embodiment, the method for inducing germination of a microbial spore comprises foliarly applying one or more spores and one or more germinants to plant foliage. In still another embodiment, the method for inducing germination of a microbial spore comprises foliarly applying one or more compositions described herein. The method may further comprise subjecting the plant or plant part to one or more agriculturally beneficial ingredients, applied simultaneously or sequentially with the one or more microbial spores or one or more germinants. In one embodiment the one or more agriculturally beneficial ingredients are applied simultaneously or sequentially with the one or more microbial spores. In another embodiment the one or more agriculturally beneficial ingredients are applied simultaneously or sequentially with the one or more germinants.

In another embodiment, a method for treating soil is also described herein. In one embodiment, the method comprises contacting a soil with one or more microbial spores and one or more germinants. In another embodiment, the method comprises contacting a soil with one or more microbial spores and one or more germinants, and growing a plant or plant part in the treated soil. In still yet another embodiment, the method comprises contacting a soil with one or more of the compositions described herein, and growing a plant or plant part in the treated soil. In an embodiment, the contacting step can be performed by any method known in the art. Non-limiting examples of contacting the soil include spraying the soil, drenching the soil, dripping onto the soil, sprenching, in-furrow sprays, pellets, microgranules, and/or dusting the soil. In one embodiment, the contacting step is repeated (e.g., more than once, as in the contacting step is repeated twice, three times, four times, five times, six times, etc.). In one embodiment, the contacting step comprises contacting the soil with one or more microbial spores sequentially with one or more germinants. In another embodiment, the contacting step comprises contacting the soil with one or more microbial spores or conidida simultaneously with one or more germinants. In a particular embodiment, the contacting step comprises introducing one or more of the compositions described herein to the soil.

The contacting step can occur at any time during the growth of the plant or plant part. In one embodiment, the contacting step occurs before the plant or plant part begins to grow. In another embodiment, the contacting step occurs after the plant or plant part has started to grow. In another embodiment, the contacting step with pests (e.g. insects, mites or nematodes) can occur at any stage in their development. For example, developmental stages such as, for example, eggs, nymphs, larvae pupae and adults may be targetted at low, medium and high infestation levels.

In another embodiment, the method further comprises the step of planting a plant or plant part. The planting step can occur before, after or during the contacting step. In one embodiment, the planting step occurs before the contacting step. In another embodiment, the planting step occurs during the contacting step (e.g., the planting step occurs simultaneously with the contacting step, the planting step occurs substantially simultaneous with the contacting step, etc.). In still another embodiment, the planting step occurs after the contacting step.

In another aspect, seeds may be treated with one or more microbial spores and one or more germinants according to any method known in the art. In a particular embodiment, seeds may be treated with one or more of the compositions described herein. In yet another embodiment, the compositions described herein are formulated (e.g., mixed, added, etc.) with a any seed treatment mixture. Coating of the seed may occur, for example, via spraying or dripping.

The combination of the present disclosure is applied in an effective amount. An effective amount of a one or more microbial spores of a biological control agent and one or more germinants is an amount sufficient to control or inhibit the pathogens. In other embodiments, the effective amount of a one or more microbial spores and one or more germinants is an amount sufficient to induce spore germination of the one or more microorganisms (i.e. of the one or more microbial spores of the biological control agent). The actual effective dosage in absolute value depends on factors including, but not limited to, synergistic or antagonistic interactions between the other active or inert ingredients which may enhance or reduce the germinating effects of the one or more germinants, and the stability of the one or more germinants in compositions and/or as plant or plant part treatments. The rate of application of the one or more microbial spores of a biological control agent and one or more germinants may vary according to the pathogen being targeted, the crop to be protected, the severity of the disease, the climate conditions, and the like. In some cases the combination of the microbial spores of a biological control agent and the germinants may show synergistic activity, where the combination of the two exceeds that expected from their simple additive effect.

For example, the one or more microbial spores of a biological agent or biological control agent (e.g. C. rosea, B. bassiana, C. javanica or T. asperellum) of the present disclosure are formulated as a liquid suspension or in a dry powder according to any suitable methods known in the art. The biologically pure culture, suspension or formulation (comprising, but not limited to, conidia, mycelium fragments and spores) is applied to the soil, pest, plant or plant part at a concentration of between about 10³ to 10¹² cfu (“colony forming unit”)/ml, about 10⁴ to 10¹¹ cfu/ml, about 10⁵ to 10¹⁰ cfu/ml or about 10⁶ to 10⁹ cfu/ml. The one or more microbial spores of a biological control agent (e.g. C. rosea B. bassiana, C. javanica or T. asperellum) is applied to the soil, pest, plant or plant part in a liquid suspension or is present in a composition or combination at a concentration of about 1×10⁴, about 1×10⁵, about 1×10⁶, about 1×10⁷, about 1×10⁸, about 1×10⁹, about 1×10¹⁰, about 1×10¹¹, about 1×10¹², about 1×10¹³ cfu/ml or greater than 1×10¹³ cfu/ml. The one or more microbial spores of a biological agent or biological control agent (e.g. C. rosea, B. bassiana, C. javanica or T. asperellum) can also be applied to the soil, pest, plant or plant part in a dry formulation (comprising, but not limited to, conidia, mycelium fragments and spores) at a concentration of between about 10³ to 10¹² cfu/g, about 10⁴ to 10¹¹ cfu/g, about 10⁵ to 10¹⁰ cfu/g or between 10⁶ to 10⁹ cfu/g. The one or more microbial spores of a biological agent or biological control agent (e.g. C. rosea, B. bassiana, C. javanica or T. asperellum) can also be applied to the soil, pest, plant or plant part in a dry formulation at a concentration of about 1×10⁴, about 1×10⁵, about 1×10⁶, about 1×10⁷, about 1×10⁸, about 1×10⁹, about 1×10¹⁰, about 1×10¹¹, about 1×10¹², about 1×10¹³ cfu/ml or greater than 1×10¹³ cfu/g. The optimal amount can vary depending upon crop species, plant pathogens or pests and can be readily determined by those skilled in the art.

In an embodiment, the glycine betaine is applied to a plant or plant part or the amount of glycine betaine in the composition or the combination is at a concentration of at least 0.001%, 0.005%, 0.01%, 0.015%, 0.02%, 0.025%, 0.03%, 0.035%, 0.04%, 0.045%, 0.05%, 0.055%, 0.06%, 0.065%, 0.07%, 0.075%, 0.08%, 0.085%, 0.09%, 0.095%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or more than 5%, 5.5%, 6%, 6.5%, 7%, 7.5%, 8%, 8.5%, 9%, 9.5%, or more than 10%. In a preferred embodiment, the glycine betaine is applied at a concentration of at least 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.5%.

In an embodiment, the yeast extract is applied to a plant or plant part or the amount of yeast extract in the composition or the combination is at a concentration of at least 0.001%, 0.005%, 0.01%, 0.015%, 0.02%, 0.025%, 0.03%, 0.035%, 0.04%, 0.045%, 0.05%, 0.055%, 0.06%, 0.065%, 0.07%, 0.075%, 0.08%, 0.085%, 0.09%, 0.095%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or more than 5%, 5.5%, 6%, 6.5%, 7%, 7.5%, 8%, 8.5%, 9%, 9.5%, or more than 10%. In a preferred embodiment, the yeast extract is applied at a concentration of at least 0.05%, 0.06%, 0.07%, 0.08%, 0.09%, 0.1%, 0.2%, 0.3%, 0.4%, 0.5%, 0.6%, 0.7%, 0.8%, 0.9% or 1%.

In some embodiments, Colby's formula is applied to determine whether using (a) and (b) in combination shows a synergistic effect: S. R. Colby, Calculating Synergistic and Antagonistic Responses of Herbicide Combinations, WEEDS 15, p. 20-22 (1967).

The following equation is used to calculate the expected activity of mixtures containing two active ingredients, A and B:

Expected=A+B−(A×B/100)

wherein
A=observed efficacy of active component A (e.g. one or more microbial spores of a biological control agent and more particularly, one or more C. rosea f. catenulatum spores) at the same concentration as used in the mixture;
B=observed efficacy of active component B (e.g. glycine betaine and/or yeast extract) at the same concentration as used in the mixture.
E=expected effect (in percent, %) of (a)+(b) at application rates a and b.

In the Colby equation, the value E corresponds to the effect (plant damage or injury) that is to be expected if the activity of the individual compounds is additive. If the observed effect is higher than the value E calculated according to the Colby equation, then a synergistic effect is present according to the Colby equation.

In some embodiments, the combinations, compositions and methods disclosed herein are synergistic as defined by the Colby equation. In some embodiments, the joint action of C. rosea f. catenulata J1446 (i.e. the microbial spores of the biological control agent) and glycine betaine (i.e. the germinants) or yeast extract results in enhanced activity (via synergism) against a plant pathogen (as, for example, against Botrytis, Rhizoctonia, Erysiphe or Venturia). In an embodiment, the combinations, compositions and methods of the present disclosure show an enhanced antimicrobial (or, for example, antifungal) or pesticidal activity compared to the antimicrobial (or, for example, antifungal) or pesticidal activity of the components when applied individually. In a further embodiment, the combinations, compositions and methods of the present disclosure show a synergistically enhanced antimicrobial (or, for example, antifungal) or pesticidal activity compared to the antimicrobial or pesticidal activity (or, for example, antifungal) of the active components when applied individually. More particularly, it has been demonstrated that the use of the combination of C. rosea f. catenulata J1446 (i.e. the microbial spores of the biological control agent) and glycine betaine (i.e. the germinants) shows an enhanced antifungal activity compared to the antifungal activity of the components when applied individually. More particularly, it has been demonstrated that the use of the combination of C. rosea f. catenulata J1446 (i.e. the microbial spores of the biological control agent) and glycine betaine (i.e. the germinants) shows an enhanced activity against Botrytis compared to the activity of C. rosea f. catenulata J1446 or glycine betaine when applied individually. The combination of C. rosea f. catenulata J1446 (i.e. the microbial spores of the biological control agent) and glycine betaine (i.e. the germinants) increases the effectiveness of the protection against attack by plant pathogens by increasing the germination of the spores and, thus, by enhancing the fungal growth and colonization of the plant or plant part. In other words, the present disclosure demonstrates an enhanced efficacy of C. rosea f. catenulata J1446 in the biological control (or fungicidal activity) of pathogenic fungi (e.g. against Botrytis, Rhizoctonia, Erysiphe or Venturia) by increasing the spore germination rate of the fungus by using a germinant. In an embodiment, and as demonstrated in the example, the combination of the present disclosure provides synergistic activity in controlling said plant pathogen or pest.

In some embodiments, the combinations, compositions and methods disclosed herein can, based on the individual components, be used at lower application rates to achieve a fungicidal effect comparable to the effect produced by the individual components at normal application rates.

In an embodiment, the use of the combinations, composition or method of the present disclosure could also be effective to control pests, mites or insects and/or to increase the effectiveness of the protection against peast or insects. For example, in this case, the one or more microbial spores of a biological control agent is selected for its ability against insects as, for example, the following biological agent controls: Beauveria bassiana sensu lato (Bals.) VuilL, B. brongniartii (Sacc.) Petch, Isaria fumosorosea Wise (formerly Paecilomyces fumosoroseus), Isaria javanica (Cordyceps javanica), Lecanicillium longisporum and L. muscarium (Petch) R. Zare and W. Gams (formerly Verticillium lecanii), Nomuraea rileyi (Farl.) Samson or Metarhizium anisopliae sensu lato (Metsch.) Sorokin. For example, the results in the present disclosure demonstrate that glycine betaine, yeast extract or a combination thereof with B. bassiana or C. javanica present an enhanced or superior entomopathogenic activity as compared to the efficacy of the biological control agent without the germinant (i.e. glycine betaine, yeast extract or a combination thereof).

The combination or composition of the present disclosure may include a suitable carrier and/or diluent and may be provided in a form of a solid, a powder, a solution, dispersion, a suspension, a paste, an aerosol or a spray, wherein the active ingredients of the present disclosure are formulated in a manner which suits the specific application. Non-limiting examples of suitable, formulations are: emulsion concentrates, suspension concentrates, water dispersible granule and wettable powders. The carrier or diluent, which is an agriculturally acceptable carrier or diluent, may be any one or more of a number of carriers that confer a variety of properties, such as increased stability, wettability, dispersability, etc. Suitable carriers may include, but are not limited to, water or other aqueous solutions, slurries, solids (e.g., peat, wheat, bran, vermiculite, pasteurized soil, etc) or dry powders. The composition or formulation may include additional additives including, but not limited to, oils, buffering agents, surfactants, adjuvants, or coating agents. The combination or composition may also comprise, for example, an additional biocontrol agent such as an antifungal agent or pesticide (insecticide, fungicide, nematicide, bacteriocide or herbicide). The combination of the one or more microbial spores of a biological control agent and one or more germinants can be applied as a single dose exposure or in multiple doses or exposures at different times.

The word “comprising” in the claims may be replaced by “consisting essentially of” or with “consisting of,” according to standard practice in patent law.

The following example serves to further describe and define the invention, and is not intended to limit the invention in any way.

### Example 1: Studies were Conducted to Evaluate the Effect of Glycine Betaine or Yeast Extract in Combination with Prestop® (C. Rosea f. Catenulata J1446) on Strawberry Plants

Materials and Methods:

(a) Inoculating Strawberry Plants

Young strawberry plants (Fragaria×ananassa; “Merced” variety) were allowed to grow at least a week before plants were selected for experiments by healthy appearance and having large leaves facing upwards. Spore counts for C. rosea f. catenulata J1446 in the package of Prestop WG used were calculated via haemocytometer to be 1.4×10¹⁰ spores/g and viability of the spores was checked using the MPN (most probably number) method and C. rosea f. catenulata J1446 was calculated to be 3×10⁹ CFU/g. Treatments were prepared using 0.025% Prestop® WG in Tween 0.02% with 0.04% Folwin, 0.2% Folwin, 0.06% Glycine Betaine (Intracell®, Lallemand), and 0.6% Glycine Betaine (Intracell®, Lallemand) as well as a 0.025% Prestop WG alone as a control. To spray the strawberry plants, 10 ml of each treatment was loaded into a Mastercraft Air Brush Kit with the mini compressor set at approximately 15 psi. For each treatment group, 17 plants were sprayed in a circular motion for 10 s. On average, 0.5 ml of treatment was calculated to be applied per plant. Each coverslip (and the leaf it was attached to) was removed from each plant after spraying, and the slip was placed into a tube containing 1 ml of a 0.02% Tween suspension along with three 3 mm glass beads. To ensure homogenization of the mixture, tubes were vortexed for 30 s, attached to the shaker (220 rpm for 10 min), and then vortexed again 10 s immediately before loading into a hemocytometer for spore counting. The number of spores obtained from each slip was counted using a hemocytometer to determine deposition rate. Plants were kept in either the greenhouse (Avg. temp 24° C., High 41° C., Low 15° C., Avg. RH 60%) or in environmental chambers (Avg. temp 28.8° C., High 30.9° C., Low 25.2° C., Avg. RH 75%) for the duration of the experiment being done. Plants for germination studies were kept at these temperatures for 6, 7, 8 or 24 h after being sprayed before leaf discs were cut. Plants used for hyphal growth studies were kept at these temperatures for 1, 2, 3 or 6d to allow C. rosea f. catenulata J1446 more time to colonize the leaf surface before leaf discs were cut. Plants used for visualising colonization were kept at these temperatures for 3 and 6 days after spraying before leaf discs were cut. Plants were watered every second day with approximately 250 ml (1 cup) of water per pot. All plants were removed from greenhouse within 14 days of the start of the experiment; cutting leaf discs in some cases caused irreparable damage to the plant.

(b) Percent Germination of C. rosea f. Catenulata J1446 on Strawberry Leaf Discs

On the same day, after spraying, two 6 mm leaf discs were cut using a sterilized staples hole punch from two different leaves per plant from five sprayed strawberry plants per treatment group per time period (6, 7, 8 and 24 h) and then dyed with 5 ul lactophenol cotton blue. Stained leaf discs were then observed under a compound microscope at 200× magnification. Three viewing areas were chosen at random on each leaf disc and 100 spores were counted: the number that germinated (germ tubes visible at twice the length of the spore) out of that 100 was recorded. Average germination percentages were analyzed per treatment group and per time period.

(c) Hyphal Growth of C. rosea f. Catenulata J1446 from Leaf Discs onto Agar Plates

Two 6 mm leaf discs were cut using a sterilized staples hole punch from two different leaves per plant from five sprayed plants per treatment per time period (1, 2, 3, and 6 days after spraying) and placed adaxial side downwards onto paraquat-chloramphenicol agar (PCA) medium (0.1 mL paraquat, 200 mg chloramphenicol, and 12 g agar per liter of water). PCA plates containing leaf discs were incubated at room temperature (±23° C.) upside right in partial light and checked daily for growth. After the second day, plates were flipped over to minimize condensation. Growth around the leaf disc was measured with a ruler and recorded as average diameter of growth per day. If the treatments were successful at enhancing fungal growth and colonization on the leaf disc, then larger growth rings of the fungus would be expected to grow off the leaf discs onto the plates as well. Averages in treatments were analyzed.

(d) Statistical Analyses

i. Deposition of Treatments onto Strawberry Plants

Deposition data was normal when the distribution was analysed for both greenhouse and environmental chamber studies. Data sets for both growth conditions were analysed using a one-way ANOVA and multiple comparisons of the mean (alpha=0.05) were analysed using a Tukey post hoc test.

ii. Germination on Strawberry Leaf Discs

Data for percent germination assays on strawberry leaves was normal when the distribution was analyzed for both greenhouse and environmental chamber studies. Therefore, data sets for both growth conditions were analysed using a one-way ANOVA and multiple comparisons of the mean (alpha=0.05) were analysed using a Tukey post hoc test.

iii. Hyphal Growth on Strawberry Leaf Discs onto Agar Plates

Data for growth bioassays from 1, 2, 3, and 6 days of greenhouse incubation were all normal when distribution was analysed. Data for growth bioassays from 1, 3, and 6 days of environmental chamber incubation were also all normal when distribution was analysed. Therefore, data sets from all incubation periods and growth conditions were analysed using a full factorial repeated measures mixed model with the following model parameters: time, treatment, and their interaction. Multiple comparisons of the mean (alpha=0.05) were analysed using a Tukey post hoc test.

Results:

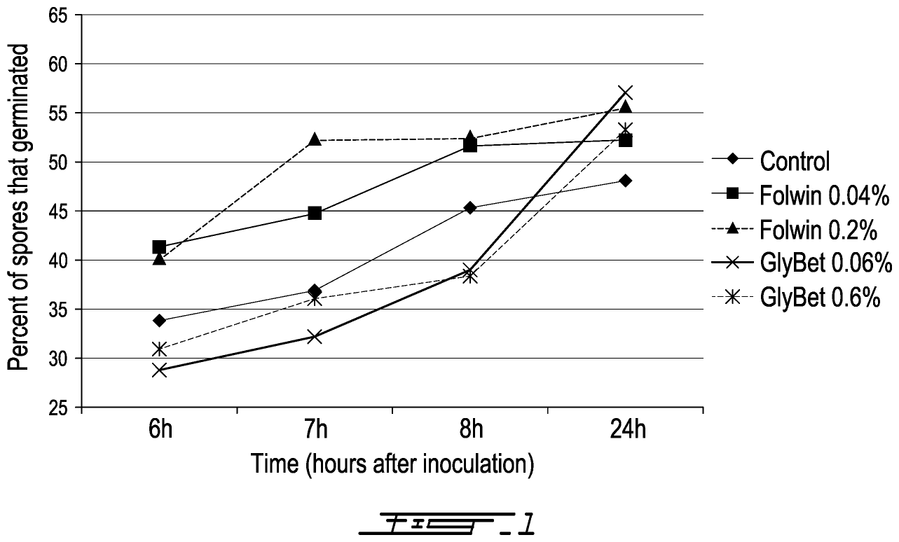

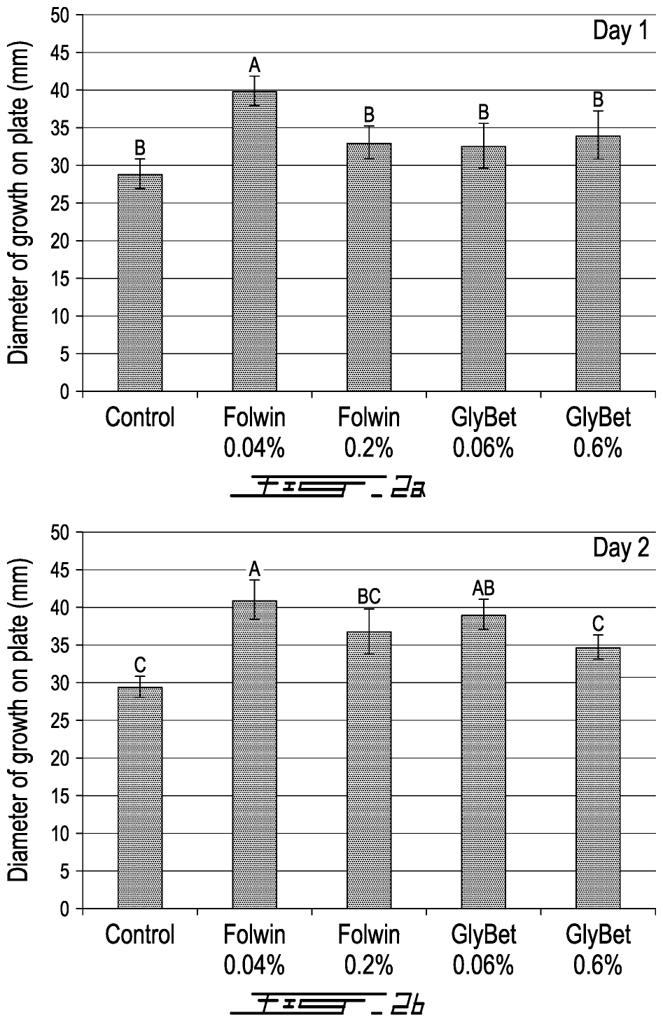

Percent germination of C. rosea f. catenulata J1446 on leaf discs: Percent germination over time (FIG. 1) was statistically significant F (_{3,695})=78.01; p<0.0001 as we observed a general trend that germination increased as time increased. The percentage of spore germination of C. rosea J1446 after 24 h was increased by the addition of glycine betaine or yeast extract.

i. Greenhouse Studies

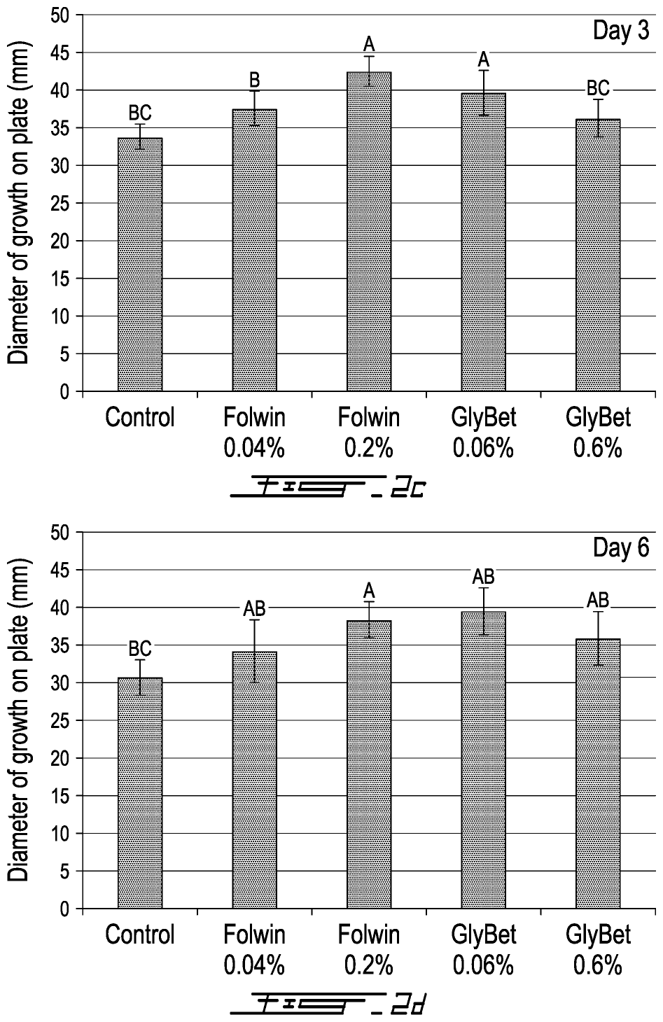

Discs were cut after plants were incubated in the greenhouse for different amounts of time (1 day, 2 day, 3 day, 6 day) and then growth was monitored on the plate for 6 days (FIG. 2). The colonization of leaf discs by C. rosea J1446 was significantly increased by the addition of glycine betaine or yeast extract.

### Example 2: Greenhouse Experiments were Performed to Demonstrate the Efficacy of the Combination of C. rosea f. Catenulata J1446 and Glycine Betaine in Controlling Botrytis cinerea

Botrytis cinerea was grown on potato dextrose broth for 1 to 2 weeks without shaking. The resulting mycelial and spores were recovered to produce a liquid inoculum.

Tomato plants, variety Admiro (stage: 3-leaf), were sprayed with the B. cinerea inoculum (5000 sp/ml) then allowed to dry. Then, the treatments were applied by spraying the inoculated tomato plants.

The following treatments were tested (9 repetitions): (T1) Prestop® (C. rosea f. catenulatum J1446) 0.003%; (T2) Prestop® (C. rosea f. catenulatum J1446) 0.003%+glycine betaine (Intracell®, Lallemand) 0.05%; (T3) Prestop® (C. rosea f. catenulatum J1446) 0.003%+glycine betaine (Intracell®, Lallemand) 0.2%; (T4) glycine betaine (Intracell®, Lallemand) 0.2% and (T5) water.

The plants were placed in greenhouse (Avg. temp 24° C., High 41° C., Low 15° C., Avg. RH 60%) and incubated 5 days. Symptom development was evaluated by measuring the size of the necrotic area (width measurement).

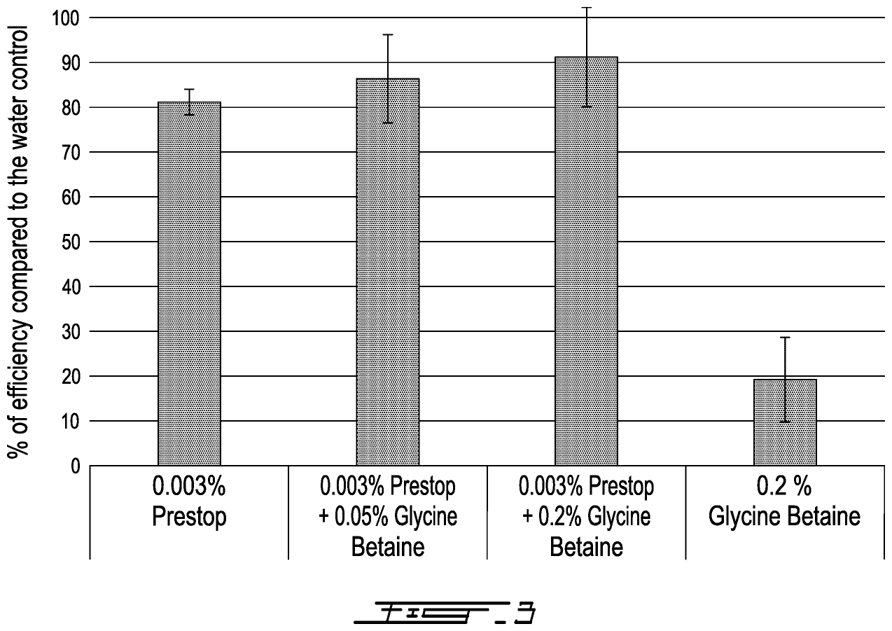

As shown in FIG. 3, the efficacy of Prestop® to control B. cinerea was increased by the combination with glycine betaine.

Colby's equation was used to determine the effects expected from the components, as described above. The results were measured at 5 days after the application of the components. As shown above, the samples demonstrated synergistic anti-Botrytis effect, with higher measured control than would be predicted by the Colby equation (observed 91>expected 84.79).

### Example 3: Greenhouse Experiments were Performed to Demonstrate the Efficacy of Lower Dose Rates of C. rosea f. Catenulata J1446 in Combination with Glycine Betaine in Controlling Botrytis cinerea

The objective of the study was to evaluate the protection efficiency of lower dose rates of C. rosea f. catenulata J1446 in combination with glycine betaine against Botrytis cinerea.

The assay was performed on young tomato plantlet (variety Admiro), susceptible to grey mold. Plants were raised in greenhouse for 3 weeks (until the 2 leaf stage) before being used for the assay.

Botrytis cinerea (fungal pathogen causing the tomato grey mold) inoculum was obtained by multiplication on PDA (Potatoes Dextrose Agar) growth medium.

Ounce they had reached the two leaf stage, plants were treated using a glass sprayer (foliar spray). Products (or water for the control) were sprayed until run off.

Tomato grey mold symptom development has been evaluated measuring the size of the necrotic area (width measurement).

The assay was organized in 10 independent repetitions of one plant per modality.

The different modalities were compared to a negative control treated with water.

The following treatments were tested: (T1) water; (T2) Prestop® (C. rosea f. catenulatum J1446) 0.001%; (T3) Prestop® (C. rosea f. catenulatum J1446) 0.001%+glycine betaine (Intracell®, Lallemand) 0.08%; (T4) Prestop® (C. rosea f. catenulatum J1446) 0.001%+glycine betaine (Intracell®, Lallemand) 0.06%; (T5) glycine betaine (Intracell®, Lallemand) 0.08%; and (6) glycine betaine (Intracell®, Lallemand) 0.06%.

The treatments were performed at day-1, the Botrytis cinerea inoculation was performed at day 0 and the symptom evaluation was done at day +5. The plants were placed in greenhouse (Avg. temp 24° C., High 41° C., Low 15° C., Avg. RH 60%). Symptom development was evaluated by measuring the size of the necrotic area (width measurement in mm).

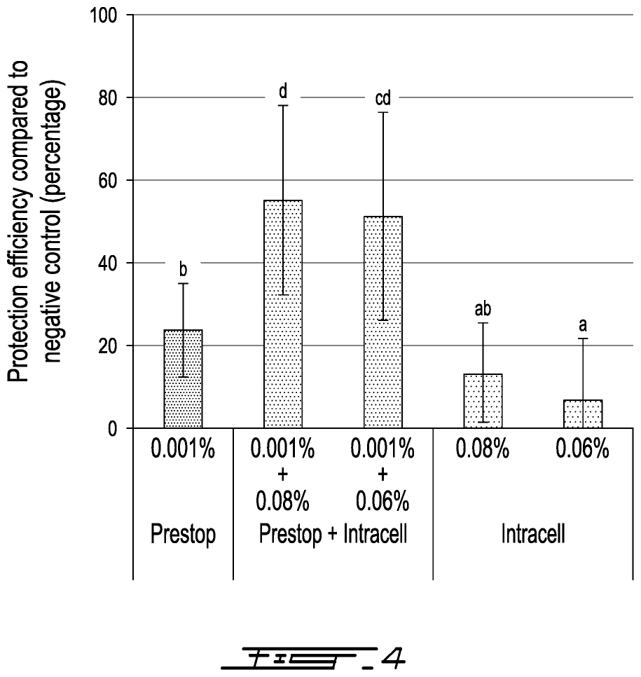

FIG. 4 shows the protection efficiency of the different treatments in comparison with the negative control. At the two tested doses, protection efficiency of the combination of Prestop® and glycine betaine was significantly higher than the Prestop® or glycine betaine alone. Also, observed and predicted values as calculated by the Colby's equation: for 0.08% of glycine betaine: observed if 55.2 and expected is 34.2; for 0.06% glycine betaine: observed is 51.4 and expected is 29.06.

### Example 4: A Study was Conducted to Demonstrate the Efficiency of the Combination of C. Rosea f. Catenulata J1446 in Combination with Glycine Betaine in Inducing Vine Resistance to Powdery Mildew (Erysiphe necator)

The trials were carried out on herbaceous vine cuttings with four to five adult leaves grown in greenhouses (Marselan grape variety) at a rate of ten plants per modality. The study consisted of treating the vine cuttings with the different treatments, four days before inoculation and two days after inoculation. The treatments were applied by spraying on both sides of the leaves up to the runoff point.

The inoculation was carried out by spraying a suspension of 10⁵ powdery mildew conidia/mL on the upper surface of the leaves. Treated and inoculated cuttings were placed in greenhouse. The incubation was conducted in conditions: 25° C. during the day and 18° C. at night with a photoperiod of 18 hours until the end of the experimentation.

The efficacy of the different treatments was evaluated at 18 days post-inoculation by scoring (visual estimation) of the infected area of leaves in “rows” 1, 2 and 3 (first three “adult” leaves from the apex) relative to an untreated control: 0=no infection; 1=a few points; 2=a few small non-contiguous spots; and 3=large spots, contiguous or not.

The results were analysed using an analysis of variance (alpha=0.05) and multiple comparisons of the mean were analysed using a ISD Fisher test.

The following treatments were tested: (T1) water; (T2) glycine betaine (Intracell®, Lallemand) 0.5 g/L; (T3) Prestop® (C. rosea f. catenulatum J1446) 0.7 g/L+glycine betaine 0.5 g/L; and (T4) Prestop® (C. rosea f. catenulatum J1446) 0.7 g/L.

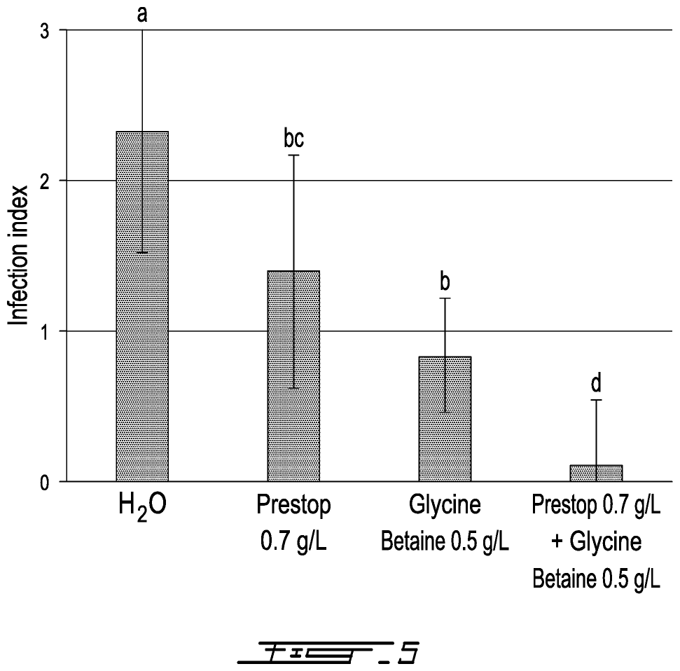

Results are shown in FIG. 5. It has been demonstrated that the combination of Prestop® and glycine betaine conferred a protective effect on the development of powdery mildew which protective effect is statistically significant compared to the other treatments. It is concluded that glycine betaine increases the effectiveness of Prestop® (C. rosea f. catenulatum J1446). A partial systemic effect was also observed as the post-treatment formed leaves and the anticipated leaves developed after treatments were almost asymptomatic.

### Example 5: A Study was Conducted to Demonstrate the Efficiency of the Combination of Prestop® (C. Rosea f. Catenulata J1446) in Combination with Glycine Betaine to Fight Against Rhizoctonia and Botrytis sp. in Lettuce Crop Under Greenhouse Conditions

The assay was carried out on lettuce (variety météore). Lettuces were grown under greenhouse conditions naturally contaminated by Rhizoctonia and Botrytis sp. with four repetitions for each treatments. Each plots of land (40 lettuces per plot) included four rows having a length of 5 m and a width of 1.32 m.

The following treatments were tested: (T1) water; (T2) Prestop® (C. rosea f. catenulatum J1446) 0.025%; and (T3) Prestop® (C. rosea f. catenulatum J1446) 0.025%+glycine betaine (Intracell®) 0.6%. The first application was done by soaking the lettuce in the solutions during 20 seconds. The three subsequent applications of the treatments on the lettuce was carried out by spraying at a rate of 500 L/ha on the leaves in three subsequent applications.

Evolution of disease frequency was evaluated three time during crop development (transplanting +10; +20; +30 days) and at harvest. Scoring was performed by presence/absence of the disease on 40 plants from the four rows. Disease intensity and severity were assessed at the harvest on 20 plants from the four rows following the given scale: Grade 1: healthy lettuce; Grade 2: low attack, color and basal leaves infested; Grade 3: strong attack, numerous infested leaves; and Grade 4: very strong attack, unmarketable lettuces. Marketable lettuces are those found with a score of 1 and 2.

The results (average comparison on disease frequency and yield) were analysed using an analysis of variance (alpha=0.05). A Khi² test was performed on Botrytis sp and Rhizoctonia intensity and severity at harvest.

Phytotoxicity scorings were performed three and seven days after each application. No phytotoxity symptoms nor effects on non-targeted organisms were found in this trial.

In accordance with the protocol, frequency scoring on 40 lettuces per plot started 10 days after planting, and 20 days, but no one symptom was observed. Botrytis sp. attacks appeared at the third notation (planting +27 days). Two scoring were done after.

Results have indicated that Rhizoctonia and Botrytis attack was strong in the trial with around 100% of infested lettuces in the untreated control (grade 2-4). The control presents significantly less healthy lettuce and more lettuce unmarketable grade 4 (results of Khi² is below).

As indicated in Table 1, the treatments with Prestop in combination with glycine betaine significantly augment the number of healthy lettuce.

Khi² tests performed on intensity scoring collar rot at harvest can be understood according to these codes:

TABLE 1
Khi² test on “collar rot” intensity at harvest.

| Treatments | Grade 1 | |
|---|---|---|
| T1 - Control | 1% | (−) ** |
| T2 - Prestop | 12% | (+) * |
| T3 - Prestop ® + | 20% | (+) *** |
| glycine | | |

(+): observed headcount higher than theorical headcount
(−): observed headcount lower than theorical headcount
NS: non-significant Khi² at 0.100 threshold
*: significant Khi² test at 0.100 threshold
**: significant Khi² test at 0.05 threshold
***: significant Khi² test at 0.010 threshold

### Example 6: A Study was Conducted to Evaluate the Efficiency of the Combination of Prestop® (C. rosea f. Catenulata J1446) in Combination with Glycine Betaine to Reduce the Inoculum of Apple Scab (Venturia inaequalis) in an Apple Orchard

The trial was carried out on potted trees of the Gala variety. Six trees per treatment were reserved for this test.

The following treatments were tested: (T1) water; (T2) Prestop® (C. rosea f. catenulatum J1446) 250 g/ha+Silwet L-77 0.25 ml/l; (T3) Prestop® (C. rosea f. catenulatum J1446) 250 g/ha+glycine betaine (Intracell®, Lallemand) 300 g/ha; and (T4) glycine betaine (Intracell®, Lallemand) 300 g/ha. Two application strategies were tested: (a) one application four days before pathogen inoculation; and (b) a first application four days before pathogen inoculation and a second application after pathogen inoculation when a cumulative of 300° C./hour was reached after the inoculation.

A solution of conidia of V. inaequalis was prepared from 2018 scabbed leaves stored in the freezer. The trees were kept under fog for at least one hour before contamination and then at least 12 hours afterwards. The duration was adapted according to ambient temperature and humidity. The spray volume was defined after a blank test to cover sufficient vegetation without reaching the runoff point (between 30 and 50 mL/tree). The treatments were applied using a hand-held sprayer and carried out four days before inoculation with the pathogen (strategies (a) and (b)) and within 300° C./H after inoculation for strategy (2) only.

The frequency and intensity of foliar symptoms of scab were observed. Observation was carried out four to five days after the start of the first spots, using a 0 to 4 rating scale. Trees were scored individually and were made on all the leaves of each tree.

The results are shown in Table 2 and the treatment «Prestop®+glycine betaine» (one application before inoculation or one application before and one at 300° H after) decreased the average number of scabbed leaves by 8 to 9% compared to the control treated with water. In this experiment, Silwet is included as an adjuvant.

TABLE 2
Frequency of occurrence of foliar symptoms of scab.

| Number of applications | Frequency of foliar symptoms of scab | |
|---|---|---|
| One application four days | Water | 63.0% |
| before inoculaton with the | Prestop ® (C. rosea f. | 70.5% |
| pathogen | catenulatum J1446) 250 g/ha + | |
| | Silwet L-77 0.25 ml/l | |
| | Prestop ® (C. rosea f. | 53.8% |
| | catenulatum J1446) 250 g/ha + | |
| | glycine betaine 300 g/ha | |
| | Glycine betaine 300 g/ha | 59.6% |
| One application four days | Water | 56.1% |
| before inoculaton with the | Prestop ® (C. rosea f. | 56.6% |
| pathogen + a second | catenulatum J1446) 250 g/ha + | |
| application after pathogen | Silwet L-77 0.25 ml/l | |
| inoculation when a | Prestop ® (C. rosea f. | 47.9% |
| cumulative of 300° C./hour | catenulatum J1446) 250 g/ha + | |
| was reached after the | glycine betaine 300 g/ha | |
| inoculation | Glycine betaine 300 g/ha | 58.5% |

### Example 7: A Study was Conducted to Evaluate the Effect of Glycine Betaine, Yeast Extract or a Combination Thereof on the Enhancement of the Conidial Germination Rate of Beauveria bassiana

A strain of B. bassiana (Granada, Lallemand) was used in the study.

Conidia of B. bassiana were diluted in sterile distilled water containing Tween 80 (0.05%). The concentration of the treatments applied was 1×10⁶ CFU/ml.

Glycine betaine (Intracell®, Lallemand; 0.2% in 100 L/ha of spray mix) (T2), yeast extract (FNI, Lallemand; 0.2% in 100 L/ha of spray mix) (T3) and a combination of glycine betaine (Intracell®, Lallemand; 0.2% in 100 L/ha of spray mix) and yeast extract (FNI, Lallemand; 0.2% in 100 L/ha of spray mix) (T4) were tested to stimulate the conidia germination of B. beauveria.

B. bassiana conidia were paired with the three above-mentioned treatments at a ratio of 1:1. Suspension of only B. bassiana conidia in sterile distilled water plated on water agar was used as a negative control (T1). Six repetitions were made by treatment.

One hundred μL of suspension per combination (six replicates) was placed on a petri dishes containing water agar (15 g/L). The plates were incubated at 25° C. in the dark. Evaluation of germination rates and the germ-tube elongation was carried out under light microscope (at 40× magnification) after four, eight, 12 and 16 hours of incubation.

The data were submitted to normality and homogeneity tests (Shapiro-Wilk and Bartlett test). Once this meet the principles, it was subjected to ANOVA statistical analysis of variance and the means compared by the Tukey test (p<0.05). The R Studio version 1.2.1335 statistical software was used.

As shown in Table 3, the addition of glycine betaine, yeast extract or a combination thereof increased significantly the germination rate of B. bassiana conidia.

TABLE 3
Number of germinated B. bassiana conidia in suspensions containing mixtures of
conidia with the tested substances that had been incubated together for 16 hours at 25° C.

| | | Average of germinated conidia (%) per hour | | | | | | | |
|---|---|---|---|---|---|---|---|---|---|
| n. | Treatments | 4 h | | 8 h | | 12 h | | 16 h | |
| T1 | B. bassiana:-water-agar (negative control) | 0.00 | NS | 5.67 | B* | 31.00 | B | 56.50 | C |
| T2 | B. bassiana + glycine betaine | 0.00 | | 3.83 | B | 33.00 | B | 71.17 | B |
| T3 | B. bassiana + yeast extract | 0.00 | | 6.00 | B | 40.83 | B | 74.67 | AB |
| T4 | B. bassiana + glycine betaine + yeast extract | 0.00 | | 9.00 | B | 41.50 | B | 70.50 | B |

NS: Non-significant
*Means followed by the same letter do not significantly differ from each other according to Tukey's test (P > 0.05).

A bioassay was carried out to evaluate the efficacy of the combination of B. bassiana with glycine betaine, yeast extract or the combination of glycine betaine with yeast extract in controlling whiteflies (Bemisia tabaci (Gennadius) (Hemiptera: Aleyrodidae).

The treatments tested were the following ones: (T1) Tween 80 0.05% (negative control); (T2) B. bassiana (Granada, Lallemand) (positive control); (T3) B. bassiana+glycine betaine 0.2% (Intracell®, Lallemand); (T4) B. bassiana+yeast extract 0.2% (FNI, Lallemand); and (T5) B. bassiana in combination with glycine betaine 0.2% (Intracell®, Lallemand) and yeast extract 0.2% (FNI, Lallemand). Seven repetitions were made by treatment.

Conidia of B. bassiana were diluted in sterile distilled water containing Tween 80 (0.05%). The concentration of the treatments applied was 2×10⁷ CFU/ml. B. bassiana conidia were paired with the above-mentioned treatments at a ratio of 1:1.

Bean plants (two leaves-stage) were infested with adults whiteflies. After oviposition on the plants for a period of 24 hours, adults were removed and the plants were transferred to a separate room for the development of the nymphs until the second instar. Then, the abaxial surface of bean leaves were sprayed with the different treatments with the aid of an airbrush. The plants were kept in a greenhouse (temperature ranging from 14° C. to 30° C.) and the mortality was evaluated.

The data were submitted to normality and homogeneity tests (Shapiro-Wilk and Bartlett test), an analysis of deviance was performed and the means compared by the Tukey test (p<0.05). The R Studio version 1.2.1335 statistical software was used.

As shown in Table 4, the results indicate that there is a superior entomopathogenic activity when B. bassiana is combined with glycine betaine, yeast extract or a combination of glycine betaine with yeast extract compared to the controls.

TABLE 4
Average of nymph mortality (in %) 10 days
after application of the treatments

| | | Average of nymph mortality (%) |
|---|---|---|
| n. | Treatments | 10 days after application |
| T1 | Tween 80 0.05% (negative control) | 2.52c |
| T2 | B. bassiana (Granada, Lallemand) | 3.53c |
| | (positive control) | |
| T3 | B. bassiana + glycine betaine | 9.33b |
| T4 | B. bassiana + yeast extract | 16.42a |
| T5 | B. bassiana + glycine betaine + | 11.26b |
| | yeast extract | |

* Means followed by the same letter do not significantly differ from each other according to Tukey's test (P > 0.05).

### Example 8: Study was Conducted to Evaluate the Effect of Glycine Betaine, Yeast Extract or a Combination Thereof on the Enhancement of the Conidial Germination Rate of Cordyceps javanica

Conidia of C. javanica were diluted in sterile distilled water containing Tween 80 (0.05%). The concentration of the treatments applied was 1×10⁶ CFU/ml.

Glycine betaine (Intracell®, Lallemand; 0.2% in 100 L/ha of spray mix) (T2), yeast extract (FNI, Lallemand; 0.2% in 100 L/ha of spray mix) (T3) and a combination of glycine betaine (Intracell®, Lallemand; 0.2% in 100 L/ha of spray mix) and yeast extract (FNI, Lallemand; 0.2% in 100 L/ha of spray mix) (T4) were tested to stimulate the conidia germination of C. javanica.

C. javanica conidia were paired with the three above-menetioned treatments at a ratio of 1:1. Suspension of only C. javanica conidia in sterile distilled water plated on water agar was used as a negative control (T1).

One hundred μL of suspension per combination (six replicates) was placed on a petri dishes containing water agar (15 g/L). The plates were incubated at 25° C. in the dark. Evaluation of germination rates and the germ-tube elongation was carried out under light microscope (at 40× magnification) after four, eight and 12 hours of incubation.

The data were submitted to normality and homogeneity tests (Shapiro-Wilk and Bartlett test). Once this meet the principles, it was subjected to ANOVA statistical analysis of variance and the means compared by the Tukey test (p<0.05). The R Studio version 1.2.1335 statistical software was used.

As shown in Table 5, the addition of glycine betaine, yeast extract or a combination thereof increased the germination rate of C. javanica conidia. Results indicated that the conidial germination was stimulated more strongly by yeast extract and the combination of glycine betaine and yeast extract.

TABLE 5
Number of germinated C. javanica conidia
in suspensions containing mixtures of conidia with the tested
substances that had been incubated together for 12 hours at 25° C.

| | | Average of germinated | | | | | |
|---|---|---|---|---|---|---|---|
| | | conidia (%) per hour | | | | | |
| n. | Treatments | 4 h | | 8 h | | 12 h | |
| T1 | C. javanica | 0.00 | ns* | 22.5 | C | 85.67 | C |
| | (Negative control) | | | | | | |
| T2 | C. javanica + glycine betaine | 0.00 | | 53 | B | 88.5 | BC |
| T3 | C. javanica + yeast extract | 0.00 | | 82.5 | A | 93.17 | AB |
| T4 | C. javanica + glycine | 0.00 | | 84.5 | A | 93.5 | AB |
| | betaine + yeast extract | | | | | | |

NS: Non-significant
*Means followed by the same letter do not significantly differ from each other according to Tukey′s test (P > 0.05).

A bioassay was carried out to evaluate the efficacy of the combination of C. javanica with yeast extract or the combination of glycine betaine with yeast extract in controlling whiteflies (Bemisia tabaci (Gennadius) (Hemiptera: Aleyrodidae).

The treatments tested were the following ones: (T1) Tween 80 0.05% (negative control); (T2) C. javanica (positive control); (T3) C. javanica+yeast extract 0.2% (FNI, Lallemand); and (T4) C. javanica+glycine betaine 0.2% (Intracell®, Lallemand)+yeast extract 0.2% (FNI, Lallemand). Seven repetitions were made by treatment.

Conidia of C. javanica were diluted in sterile distilled water containing Tween 80 (0.05%). The concentration of the treatments applied was 2×10⁷ CFU/ml. C. javanica conidia were paired with the above-mentioned treatments at a ratio of 1:1.

Bean plants (two leaves-stage) were infested with adults whiteflies. After oviposition on the plants for a period of 24 hours, the plants were transferred to a separate room for the development of the nymphs until the second instar. Then, the abaxial surface of bean leaves were sprayed with the different treatments with the aid of an airbrush. The plants were kept in a greenhouse (temperature ranging from 14° C. to 30° C.) and the mortality was evaluated.

The data were submitted to normality and homogeneity tests (Shapiro-Wilk and Bartlett test), an analysis of deviance and the means compared by the Tukey test (p<0.05). The R Studio version 1.2.1335 statistical software was used.

As shown in Table 6, the results indicate that there is a superior entomopathogenic activity when C. javanica is combined with yeast extract or yeast extract in combination with glycine betaine compared to the controls.

TABLE 6
Average of nymph mortality (in %) 7 days after application of the treatments

| | | Average of nymph mortality (%) |
|---|---|---|
| n. | Treatments | 7 days after application |
| T1 | Tween 800.05% (negative control) | 1.68d |
| T2 | C. javanica (positive control) | 10.05c |
| T3 | C. javanica + yeast extract | 37.18a |
| T4 | C. javanica + glycine betaine + | 17.28b |
| | yeast extract | |

* Means followed by the same letter do not significantly differ from each other according to Tukey's test (P > 0.05).

### Example 9: A Study was Conducted to Evaluate the Effect of Yeast Extract on the Enhancement of the Conidial Germination Rate of Trichoderma asperellum (Quality®, Lallemand)

A laboratory trial was carried out. The following treatments were evaluated (including three repetitions): (T1) T. asperellum (Quality, Lalemand) alone 1 g/kg of seeds; and (T2) T. asperellum 1 g/kg of seeds+yeast extract (FNI, Lallemand) 1 g/kg of seeds which corresponds to a concentration of 0.001%.

Soybean seeds were weighted and 500 g of seeds was used by treatment. The products were diluted in distilled water and the seeds were inoculated by spraying. After the treatments, the seeds were stored in a fresh and ventilated environment.

After the seed incoluation, the germination percentage of viable conidia was evaluated. Two samples of 100 g (16.67 g on average) inoculated seeds were weighted and distribute in two Erlenmeyers with sterile dilution solution (0.9% NaCl-0.1% Tween), forming the dilution 0. The vials were agitated for 20-30 minutes at 240 rpm. Dilutions were done in series, the solutions were plates on PDA and the petri dishes incubated at 25° C. for 7 days.

For the evaluation of the viability of conidia (in %), the seeds were washed with n isotonic solution and the resulting solution was homogenized in a vortex for 10-20 seconds. The suspension was diluted as required and plated on Petri dish containing ⅕ acidified BDA medium. This step was repeated five times for each time point: 0, 3 h, 6 h, 12 h, 16 h, 20 h hours after incubation. The plates were incubated at 25° C.

The evaluation of the viability was done using an optical microscope. Spores considered viable are those that have a germ tube equal to or larger than spore; active but not germinated spores are those that swell but do not form a germ tube; and nonviable spores are those that do not swell, do not stain with the dye solution or have a very poor color compared to the swollen ones.

The spores that had germinated were calculated using the following formula:

Viability (%)=viable conidia average/(inactive conidia average+viable conidia average)×100

The generated data were submitted to normality and homogeneity tests (Shapiro-Wilk and Bartlett test). Once these principles were met, they were submitted to statistical analysis of ANOVA variance and Tukey's test (P≤0.05). For data that did not meet the principles, they were submitted to to an analysis of deviance test and the means compared by the Tukey test (P≤0.05). The R Studio version 1.2.1335 statistical software was used.

As shown in Table 7, the percentage of conidia germination of T. asperellum was significantly increased by the addition of yeast extract.

TABLE 7
Percent of germinated T. asperellum conidia in suspensions
containing mixtures of conidia with the tested substances that
had been incubated together for 20 hours at 25° C.

| Treatments | 3 hours | 6 hours | 12 hours | 16 hours | 20 hours |
|---|---|---|---|---|---|
| T. asperellum | 0 | 0 | 1.83% b | 47.5% b | 49.5% b |
| (Quality ®, | | | | | |
| Lalemand) | | | | | |
| T. asperellum | 0 | 0 | 24.83% a | 54.5% a | 56.5% a |
| (Quality ®, | | | | | |
| Lalemand) + | | | | | |
| yeast extract | | | | | |

Means followed by the same letter do not differ statistically from each other by the Tukey test at 5% significance.

A greenhouse trial was conducted to evaluate whether the presence yeast extract would also increased the biostimulation effect of T. asperellum.

Soybean seeds were treated as mentioned above. The sowing was performed on the same day of seed treatment, allowing to approximate the reality of the field and offer favorable conditions for the survival of microorganisms. Each experimental unit consisted of two four L pot containing sand. A soybean seed with a depth of two cm (recommended for cultivation) was sown in each pot.

The percentage of number of emerged seedlings was carried out daily up to ten days of evaluation and the germination speed index was calculated according to Maguire (1962).

The experiment was conducted until the plants reached the vegetative cycle V2 (25 days). At the end of this period the plants were collected and washed in running water to minimize loss of thin roots. The root volume, aerial part length, fresh aerial part and root mass and dry aerial pat and root mass was done according to methods known in the art.

An ANOVA was conducted followed by a Tukey test for Aerial Part Length, Fresh aerial part mass, fresh root mass and dry aerial part mass. Analyses of Deviance (Gamma distribution) followed Tukey test for Emergence Speed Index, Root Volume (ml) and Dry root mass (cm) were also performed. The Software R Studio version 1.2.1335 was used for all statistical analysis.

The results demonstrated that the seeds coated with T. asperellum and yeast extract provided the highest dry root mass compared to soybean seeds treated only with T. asperellum (Table 8). This demonstrated that the presence of yeast extract increases the biostimulaton effet of T. asperellum.

TABLE 8
Biostimulation effect of T. asperellum on soybeans

| Treatments | Dry root mass (g) |
|---|---|
| Water | 0.16 c |
| T. asperellum (Quality, | 0.22 a |
| Lalemand) | |
| T. asperellum (Quality, | 0.35 b |
| Lalemand) + yeast extract | |

Means with the same letters don't differ by Tukey's test (P ≤ 0.05)

While the invention has been described in connection with specific embodiments thereof, it will be understood that the scope of the claims should not be limited by the preferred embodiments set forth in the examples, but should be given the broadest interpretation consistent with the description as a whole.

Further Aspects of the Invention:

1. A method for controlling a plant pathogen or protecting a plant from a plant pathogen, said method comprising contacting a plant or plant part with (a) one or more microbial spores of a biological control agent; and (b) one or more germinants, wherein said one or more germinants is glycine betaine, a yeast extract or a combination thereof.
2. A method for enhancing the germination rate of a microbial spore comprising contacting (a) one or more microbial spores of a biological control agent and (b) one or more germinants, wherein said one or more germinants is glycine betaine, a yeast extract or a combination thereof to a host, wherein upon contact of the one or more microbial spores and the one or more germinants to the host, the one or more microbial spores of the biological control agent exhibit increased spore germination rate on the host in the presence of the one or more germinants compared to contacting one or more microbial spores on the host without the one or more germinants.
3. A composition comprising (a) one or more microbial spores of a biological control agent; and (b) one or more germinants, wherein said one or more germinants is glycine betaine, a yeast extract or a combination thereof, and wherein said composition controls a plant pathogen.
4. Use of an effective amount of (a) one or more microbial spores of a biological control agent; and (b) one or more germinants, wherein said one or more germinants is glycine betaine, yeast extract, or a combination for enhancing the germination rate of the one or more microbial spore of a biological control agent and thereby controlling a plant pathogen wherein the use of a combination of the one or more microbial spores and the one or more germinants shows an enhanced germination rate and antimicrobial activity compared to the germination rate and antimicrobial activity of the one or more microbial spores of a biological control agent when applied individually without the one or more germinants.
5. The method of paragraph 2, wherein said host is a plant or plant part.
6. The method of paragraph 1, 2 or 5, wherein the contacting comprises foliarly applying to a plant or plant part the one or more microbial spores of a biological control agent and the one or more germinants.
7. The method of 1, 2, 5 or 6, the composition of paragraph 3 or the use of paragraph 4, wherein the one or more germinants is glycine betaine.
8. The method of 1, 2, 5 to 7, the composition of paragraph 3 or the use of paragraph 4 or 7, wherein the one or more germinants is a combination of glycine betaine and yeast extract.
9. The method of any one of paragraphs 1, 2 and 5 to 8, the composition of paragraph 3 or the use of paragraphs 4, 7 or 8 wherein the one or more microbial spores of a biological control agent is one or more fungal microbial spores.
10. The method of any one of paragraphs 1, 2 and 5 to 9, the composition of paragraph 3 or 9, or the use of any one of paragraphs 5 and 7 to 9, wherein the one or more fungal microbial spores is one or more fungal spores of Chlonostachys rosea var. catenulatum.
11. The method of any one of paragraphs 1, 2 and 5 to 10, the composition of paragraph 3, 9 or 10 or the use of paragraphs 4, 5, 7 to 10, wherein Chlonostachys rosea var. catenulatum is C. rosea f. catenulata J1446.12. The composition of paragraph of any one of paragraphs 3 and 9 to 11, wherein the composition further comprises a carrier.
13. The method of any one of paragraphs 1, 2 and 5 to 11, the composition of any one of paragraphs 3 and 9 to 12 or the use of any one of paragraphs 5 and 7 to 11, wherein the plant pathogen belongs to the genus Botrytis, Didymella, Pythium, Phytophthora, Fusarium or Rhizoctonnia.
14. The method of any one of paragraphs 1, 2, 5 to 11 and 13, the composition of any one of paragraphs 3 and 9 to 13, or the use of any one of paragraphs 5, 7 to 11 and 13, wherein the plant pathogen belongs to the genus Botrytis.
15. The method of any one of paragraphs 1, 2, 5 to 11, 13 and 14, the composition of any one of paragraphs claims 3 and 9 to 14 or the use of any one of paragraphs 5, 7 to 11, 13 and 14, wherein the plant pathogen is Botrytis cinerea.
16. The method of any one of paragraphs 1, 2, 5 to 11 and 13 to 15, or the use of any one of paragraphs 5, 7 to 11 and 13 to 15, wherein said (a) one or more microbial spores of a biological control agent, and (b) one or more germinants are used simultaneously, separately or sequentially.
17. The method of any one of paragraphs 1, 2, 5 to 11, 13 to 16, or the use of any one of paragraphs 5, 9 to 11 and 13 to 16, wherein said (a) one or more microbial spores of a biological control agent; and (b) one or more germinants are used simultaneously.
18. The method of any one of paragraphs 1, 2, 5 to 11, 13 and 17, the composition of any one of paragraphs 3 and 9 to 15 or the use of any one of paragraphs 5, 9 to 11 and 13 to 17, wherein the glycine betaine is applied to the plant or plant part at a concentration of at least 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or 5%.
19. The method of any one of paragraphs 1, 2, 5 to 11, 13 and 18, the composition of any one of paragraphs 3, 9 to 15 and 18 or the use of any one of paragraphs 5, 9 to 11 and 13 to 18, wherein the one or more microbial spores of a biological control agent is applied to the plant or plant part at a concentration of at least about 1×10⁶, about 1×10⁷, about 1×10⁸, about 1×10⁹, about 1×10¹⁰, about 1×10¹¹ or about 1×10¹² CFU/g.
20. The method of any one of paragraphs 1, 2, 5 to 11, 13 and 19, the composition of any one of paragraphs 3, 9 to 15 and 19 or the use of any one of paragraphs 5, 9 to 11 and 13 to 19, wherein the plant or plant part are cereals, maize, rice, leguminous plants, forage crop, oil- and protein-rich plants, vegetable crops, fruit trees, viticulture or ornamental crops.

1. A method for enhancing the germination rate of a microbial spore comprising contacting to a host: (a) one or more microbial spores of a biological agent or biological control agent and (b) one or more germinants, wherein said one or more germinants comprises glycine betaine, a yeast extract, a yeast derivative, or a combination thereof.

2. The method of claim 1, wherein upon contact of the one or more microbial spores and the one or more germinants to the host, the one or more microbial spores of the biological agent or biological control agent exhibit an increased spore germination compared to contacting one or more microbial spores to the host without the one or more germinants.

3. The method of claim 1 or 2, wherein the host is soil, a pest, a plant or a plant part, optionally wherein the plant part comprises or consists of a seed.

4. A method for controlling a plant pathogen or a pest or protecting a plant from a plant pathogen a pest or improving growth, development and/or productivity of a plant, said method comprising contacting soil, a pest, a plant or a plant part with (a) one or more microbial spores of a biological agent or biological control agent and (b) one or more germinants, wherein said one or more germinants comprises glycine betaine, a yeast extract, a yeast derivative, or a combination thereof.

5. A method for enhancing the efficacy of a biological agent or biological control agent, said method comprising contacting soil, a pest, a plant or a plant part with (a) one or more microbial spores of a biological agent or biological control agent and (b) one or more germinants, wherein said one or more germinants comprises glycine betaine, a yeast extract, a yeast derivative, or a combination thereof.

6. The method of claim 4 or 5, wherein upon contact of the one or more microbial spores and the one or more germinants to soil, the pest, the plant or the plant part, the one or more microbial spores of the biological control agent exhibits an improved efficacy in inhibiting plant pathogens or exhibits an increased pest control compared to contacting one or more microbial spores to the host without the one or more germinants or the one or more microbial spores of the biological agent exhibits improved efficacy in improving plant growth, development and/or productivity.

7. The method of claim 6, wherein the improving the growth, development and/or productivity of a plant comprises improving at least one of the following: the degree of mycorrhization, the rooting of the plant, the growth of the plant, the height of the plant, the flowering of the plant, the fresh biomass of the plant, the dry biomass of the plant, the yield of the plant, the nutrition of the plant, the resistance of the plant to abiotic stresses, and combinations thereof.

8. The method of any one of claims 4-7, wherein the plant part comprises or consists of a seed.

9. The method of any one of claims 3-8, wherein the contacting comprises foliarly applying to the plant or plant part the one or more microbial spores of a biological control agent and the one or more germinants.

10. A method for manufacturing a composition which comprises mixing (a) one or more microbial spores of a biological agent or biological control agent and (b) one or more germinants to obtain a composition comprising (a) the one or more microbial spores of a biological agent or biological control agent and (b) the one or more germinants, wherein said one or more germinants comprises glycine betaine, a yeast extract, a yeast derivative, or a combination thereof.

11. The method of claim 10, wherein said method further comprising mixing the (a) one or more microbial spores of a biological agent or biological control agent and (b) one or more germinants with (c) a carrier to obtain a composition comprising (a) the one or more microbial spores of a biological agent or biological control agent, (b) the one or more germinants and (c) the carrier.

12. The method of claim 10 or 11, wherein said composition is for controlling a plant pathogen or a pest or improving growth, development and/or productivity of a plant.

13. A composition for controlling a plant pathogen or a pest or improving growth, development and/or productivity of a plant, wherein the composition comprises (a) one or more microbial spores of a biological agent or biological control agent; and (b) one or more germinants, wherein said one or more germinants comprises glycine betaine, a yeast extract, a yeast derivative, or a combination thereof.

14. The composition of claim 13, which further comprises (c) a carrier.

15. Use of an effective amount of (a) one or more microbial spores of a biological agent or a biological control agent and (b) one or more germinants for enhancing the germination rate of the one or more microbial spores of a biological agent or a biological control agent, wherein said one or more germinants comprises glycine betaine, a yeast extract, a yeast derivative, or a combination thereof.

16. The use of claim 15, wherein the use enhances the germination rate of the one or more microbial spores of a biological agent or biological control agent thereby controlling a plant pathogen or pest or improving growth, and development and/or productivity of a plant.

17. The use of claim 15 or 16, wherein the use enhances the germination rate and antimicrobial activity or pesticidal activity of the one or microbial spores of the biological control agent compared to the germination rate and antimicrobial activity or pesticidal activity of the one or more microbial spores of a biological control agent when used without the one or more germinants.

18. The use of any one of claims 15-17, wherein the use enhances the germination rate and the efficacy in improving the plant growth, development and/or productivity of the one or more microbial spores of the biological agent compared to the germination rate and the efficacy in improving plant growth, development and or productivity of the one or more spores of the biological control agent when used without the one or more germinants.

19. The method of any one of claims 1-12, the composition of claim 13 or 14, or the use of any one of claims 15-18, wherein the one or more germinants comprises glycine betaine.

20. The method of any one of claims 1-12, the composition of claim 13 or 14, or the use of any one of claims 15-18, wherein the one or more germinants comprises a yeast extract or a yeast derivative, preferably wherein the one or more germinants comprises a yeast extract.

21. The method of any one of claims 1-12, the composition of claim 13 or 14, or the use of any one of claims 15-18, wherein the one or more germinants comprises a combination of glycine betaine and a yeast extract or a yeast derivative, preferably wherein the one or more germinants comprises a combination of glycine betaine and a yeast extract.

22. The method of any one of claims 1-12 and 19-21, the composition of any one of claims 13, 14 and 19-21, or the use of any one of claims 15-21, wherein the one or more microbial spores of a biological agent or a biological control agent are one or more fungal spores.

23. The method, use or composition of claim 22, wherein the one or more fungal spores are one or more spores of a fungus belonging to the genus Chlonostachys, Aureobasidium, Ampelomyces, Beauveria, Metarhizium, Metschnikowia, Myrothecium, Nomuraea, Lecanicillium, Chaetomium, Cordyceps, Coniothyrium, Dactylella, Aspergillis, Paecilomyces, Pasteuria, Nomuraea, Pochonia, Rhizophagus, Serendipita, Trichoderma, Pisolithus, Isaria, Crytococcus or Glomus, and combinations thereof.

24. The method, use or composition of claim 22 or 23, wherein the one or more fungal spores are one or more fungal spores of Chlonostachys rosea var. catenulatum, Beauveria bassiana, Cordyceps javanica, Trichoderma asperellum, or combinations thereof.

25. The method, use or composition of claim 24, wherein the one or more fungal spores are one or more entomopathogenic fungal spores.

26. The method, use or composition of claim 25, wherein the one or more entomopathogenic fungal spores are one or more entomopathogenic fungal spores of Beauveria bassiana, Cordyceps javanica, or combinations thereof.

27. The method of any one of claims 22-26, wherein the one or more fungal spores are one or more conidia or chlamydospores.

28. The method, use or composition of claim 24, wherein the one or more fungal spores are one or more fungal spores of Chlonostachys rosea var. catenulatum.

29. The method, use or composition of claim 25, wherein the Chlonostachys rosea var. catenulatum is C. rosea f. catenulata, optionally wherein the C. rosea f. catenulata is strain J1446.

30. The method of any one of claims 1-12 and 19-29, the composition of any one of claims 13, 14 and 19-29, or the use of any one of claims 15-29, wherein:
(i) the one or more microbial spores of a biological control agent are one or more spores of C. rosea f. catenulata and the one or more germinants comprises glycine betaine, optionally wherein the C. rosea f. catenulata is strain J1446;
(ii) the one or more microbial spores of a biological control agent are one or more spores of C. rosea f. catenulata and the one or more germinants comprises a yeast extract or a yeast derivative, preferably wherein the one or more germinants comprises a yeast extract, and optionally wherein the C. rosea f. catenulata is strain J1446;
(iii) the one or more microbial spores of a biological control agent are one or more spores of C. rosea f. catenulata and the one or more germinants comprises a combination of glycine betaine and a yeast extract or a yeast derivative, preferably wherein the one or more germinants comprises a combination of glycine betaine and a yeast extract, and optionally wherein the C. rosea f. catenulata is strain J1446;
(iv) the one or more microbial spores of a biological control agent are one or more spores of Beauveria bassiana and the one or more germinants comprises glycine betaine;
(v) the one or more microbial spores of a biological control agent are one or more spores of Beauveria bassiana and the one or more germinants comprises a yeast extract or a yeast derivative, preferably wherein the one or more germinants comprises a yeast extract;
(vi) the one or more microbial spores of a biological control agent are one or more spores of Beauveria bassiana and the one or more germinants comprises a combination of glycine betaine and a yeast extract or a yeast derivative, preferably wherein the one or more germinants comprises a combination of glycine betaine and a yeast extract;
(vii) the one or more microbial spores of a biological control agent are one or more spores of Cordyceps javanica and the one or more germinants comprises glycine betaine;
(viii) the one or more microbial spores of a biological control agent are one or more spores of Cordyceps javanica and the one or more germinants comprises a yeast extract or a yeast derivative, preferably wherein the one or more germinants comprises a yeast extract;
(ix) the one or more microbial spores of a biological control agent are one or more spores of Cordyceps javanica and the one or more germinants comprises a combination of glycine betaine and a yeast extract or a yeast derivative, preferably wherein the one or more germinants comprises a combination of glycine betaine and a yeast extract;
(x) the one or more microbial spores of a biological agent are one or more spores of Trichoderma asperellum and the one or more germinants comprises glycine betaine;
(xi) the one or more microbial spores of a biological agent are one or more spores of Trichoderma asperellum and the one or more germinants comprises a yeast extract or a yeast derivative, preferably wherein the one or more germinants comprises a yeast extract; or
(xii) the one or more microbial spores of a biological agent are one or more spores of Trichoderma asperellum and the one or more germinants comprises a combination of glycine betaine and a yeast extract or a yeast derivative, preferably wherein the one or more germinants comprises a combination of glycine betaine and a yeast extract.

31. The method of any one of claims 1-12 and 19-30, the composition of any one of claims 13, 14 and 19-30, or the use of any one of claims 15-30, wherein the plant pathogen is a fungus or an oomycota.

32. The method of any one of claims 1-12 and 19-31, the composition of any one of claims 13, 14 and 19-31, or the use of any one of claims 15-31, wherein the plant pathogen belongs to the genus Botrytis, Erysiphe, Rhizoctonia, Venturia, Didymella, Pythium, Phytophthora, Fusarium, Pseudoidium, Podosphaera and combinations thereof.

33. The method, composition or use of claim 32, wherein:
(i) the plant pathogen belongs to the genus Botrytis, preferably wherein the plant pathogen is Botrytis cinerea;
(ii) the plant pathogen belongs to the genus Erysiphe, preferably wherein the plant pathogen is Erysiphe necator;
(iii) the plant pathogen belongs to the genus Rhizoctonia, preferably wherein the plant pathogen is Rhizoctonia solani, Rhizoctonia bataticola; Rhizoctonia fragariae; Rhizoctonia leguminicola or Rhizoctonia oryzae, preferably wherein the plant pathogen is Rhizoctonia solani;
(iv) the plant pathogen belongs to the genus Venturia, preferably wherein the plant pathogen is Venturia inaequalis;
(v) the plant pathogen belongs to the genus Pseudoidium, preferably wherein the plant pathogen is Pseudoidium neolycopersici; or
(vi) the plant pathogen belongs to the genus Podosphaera, preferably wherein the plant pathogen is Podosphaera xanthii.

34. The method of any one of claims 1-12 and 19-30, the composition of any one of claims 13, 14 and 19-30, or the use of any one of claims 15-30, wherein the pest is an insect pest or a mite pest.

35. The method, composition or use of claim 34, wherein the pest is an insect pest.

36. The method, composition or use of claim 35, wherein the insect pest belongs to the species Diuraphis noxia, Bemisia argentifolii, Bemisia tabaci, Trialeurodes vaporariorum, Aleyrodes lonicerae, Diaphorina citri, Euphyllura olivine, Aphis gossypii, Myzus persicae, Macrosiphum euphorbiae, Aulacorthum solani, Heliothrips haemorrhoidalis, Frankliniella occidentalis, Frankliniella schulzei, Thrips tabaci, Scirtothrips dorsalis, Hercinothrips femoralis, Dalbulus maidis, Phenacoccus solenopsis, Pseudococcus longispinus, Paracoccus marginatus, Mahanarva fimbriolata, Deois flavopicta, Zulia entreriana, Notozulia entreriana, Hypothenemus hampei, Hedypathes betulinus, Cosmopolites sordidus, Gonipterus scutellatus, Agriotes spp., Plutella xyllostella, Helicoverpa armigera, Otiorhyncus sultacus, Fungus gnats, Exomala orientalis, Sciaridae, Otiorhynchus sulcatus, Strophosoma melanogrammum, S. capitatum, Phyllopertha horticola, Amphimallon solstitialis, Daktulosphaira vitifoliae, Diabrotica virgifera Spodoptera spp, Oligonychus ilicis, Planococcus citri, Anthonomus grandis, Brevicoryne brassicae or Sphenophorus levis.

37. The method, composition or use of claim 34, wherein the pest is a mite pest, optionally wherein said mite pest belongs to the species Tetranychus urticae, Tetranychus cinnabarinus, Brevipalpus phoenicis, Panonychus ulmi, Byrobia rubrioculus, Aculus schlectendali, Aculops lycopersici, Ixodes scapularis or Ixodes pacificus.

38. The method of any one of claims 1-12 and 19-33, the composition of any one of claims 13, 14 and 19-33, or the use of any one of claims 15-33, wherein the pest belongs to the species Bemisia tabaci, Bemisia argentifolii, Trialeurodes vaporariorum, Hypothenemus hampei, Cosmopolites sordidus, Sphenophorus levis, Tetranychus urticae, Anthonomus grandis, Diaphorina citri, Helicoverpa armigera, Frankliniella occidentalis, Frankliniella schulzei, Thrips tabaci, Aphis gossypii, Myzus persicae, Oligonychus ilicis, Planococcus citri, Mahanarva fimbriolata, Agriotes spp, Diabrotica spp or Dalbulus maidis.

39. The method, composition or use of claim 38, wherein the pest is Bemisia tabaci, preferably wherein the pest is Bemisia tabaci (Gennadius) (Hemiptera: Aleyrodidae).

40. The method of any one of claims 1-12 and 19-39, the composition of any one of claims 13, 14 and 19-39, or the use of any one of claims 15-39, wherein said (a) one or more microbial spores of a biological agent or biological control agent, and (b) one or more germinants are used simultaneously, separately or sequentially.

41. The method, composition or use of claim 40, wherein said (a) one or more microbial spores of a biological agent or biological control agent; and (b) one or more germinants are used simultaneously.

42. The method of any one of claims 1-12 and 19-41 or the use of any one of claims 15-41, wherein:
(i) the one or more germinants comprises or consists of glycine betaine, and wherein glycine betaine is applied to soil or to the host, plant or plant part at a concentration of at least 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or 5%;
(ii) the one or more germinants comprises or consists of a yeast extract or a yeast derivative, and wherein the yeast extract or the yeast derivative is applied soil or to the host, plant or plant part at a concentration of at least 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or 5%; and/or
(iii) the one or more microbial spores of a biological agent or a biological control agent is applied to soil or to the host, plant or plant part or the one or more microbial spores of a biological agent or a biological control agent at a concentration of at least about 1×10⁶, about 1×10⁷, about 1×10⁸, about 1×10⁹, about 1×10¹⁰, about 1×10¹¹ or about 1×10¹² CFU/g.

43. The composition of any one of claims 13, 14 and 19-41, wherein:
(i) the one or more germinants comprises or consists of glycine betaine, and wherein the glycine betaine is present in the composition at a concentration of at least 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or 5%;
(ii) the one or more germinants comprises or consists of a yeast extract or a yeast derivative, and wherein the yeast extract or the yeast derivative is present in the composition at a concentration of at least about 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5% or 5%; and/or
(iii) the one or more microbial spores of a biological agent or a biological control agent is present in the composition at a concentration of at least about 1×10⁶, about 1×10⁷, about 1×10⁸, about 1×10⁹, about 1×10¹⁰, about 1×10¹¹ or about 1×10¹² CFU/g.

44. The method of any one of claims 1-12 and 19-43, the composition of any one of claims 13, 14 and 19-43, or the use of any one of claims 15-43, wherein the plant or plant part are cereals, maize, rice, grasses, sugarcane, leguminous plants, forage crop, oil- and protein-rich plants, vegetable crops, fruit trees, viticulture crops, urban crops, or ornamental crops.

45. The method of any one of claims 1-12 and 19-44, the composition of any one of claims 13, 14 and 19-44, or the use of any one of claims 15-43, wherein the one or more germinants comprises or consists of a yeast extract, and wherein the yeast extract is a soluble yeast extract.

46. The method of any one of claims 1-12 and 19-45, the composition of any one of claims 13, 14 and 19-45, or the use of any one of claims 15-45, wherein the one or more germinants comprises or consists of a yeast derivative.

47. The method, composition or use of claim 46, wherein the yeast derivative is selected from inactive yeast, yeast cell walls (e.g. a yeast cell wall fraction or a yeast cell wall product), and combinations thereof.
